(19) United States
(12) Patent Application Publication
(10) Pub. No.: US 2010/0007471 A1
(43) Pub. Date: Jan. 14, 2010

(54) Apparatus for reading RFID tag

(75) Inventors: Michihiro Takeda, Kiyosu-shi (JP); Kazunari Taki, Nagoya-shi (JP)

Correspondence Address: DAY PITNEY LLP, 7 TIMES SQUARE, NEW YORK, NY, 10036-7311, US

(73) Assignee: BROTHER KOGYO KABUSHIKI KAISHA

(21) Appl. No.: 12/586,058

(22) Filed: Sep. 16, 2009

Related U.S. Application Data
(63) Continuation-in-part of application No. PCT/JP2008/054666, filed on Mar. 13, 2008.

(30) Foreign Application Priority Data
Mar. 27, 2007 (JP) 2007-082823

(51) Int. Cl. H04Q 5/22

(52) U.S. Cl. 340/10.3; 340/10.1

(57) ABSTRACT

This disclosure discloses an apparatus for reading with a radio frequency identification (RFID) tag comprising: a plurality of information creation devices, capable of generating a plurality of types of command signals for making an access to an RFID tag circuit element having an IC circuit part storing information and a tag antenna that transmits and receives information; a plurality of apparatus antennas connected to the plurality of information creation devices, respectively, and configured to transmit the plurality of types of command signals to the RFID tag circuit element via radio communication substantially at the same timing; and a single information processing device configured to obtain reading information by means of receiving processing of a response signal transmitted from the RFID tag circuit element according to the command signal transmitted from the apparatus antenna and received by the apparatus antenna.

### CROSS-REFERENCE TO RELATED APPLICATION

This is a CIP application PCT/JP2008/054666, filed Mar. 13, 2008, which was not published under PCT article 21(2) in English.

### BACKGROUND OF THE INVENTION

1. Field of the Invention

The present invention relates to an apparatus for reading a radio frequency identification (RFID) tag configured to read RFID tag information of an RFID tag circuit element, capable of information reading and writing contactlessly.

2. Description of the Related Art

An RFID system configured to read and write information contactlessly between a small-sized RFID tag and a reader/writer as a reading device or writing device is known. An RFID tag circuit element provided at a label-shaped RFID tag is, for example, provided with an IC circuit part storing predetermined RFID tag information and an antenna connected to the IC circuit part and carrying out information transmission and reception. If a transmission wave is transmitted to an RFID tag circuit element from the antenna of the reader, the RFID tag circuit element transmits a reply using energy of an electric wave of the transmission wave. Prior art references that read information from the RFID tag circuit element using such a reader include the one described in JP, A, 2005-298100, for example.

In this prior art reference, an operation terminal such as PC and a reader are connected and by performing a predetermined operation at the operation terminal, a file or stored information of the RFID tag circuit element held by a human is read from the reader and obtained.

On the other hand, an apparatus for producing RFID label configured to produce an RFID label by writing RFID tag information in such an RFID tag circuit element, for example, has been already proposed (See JP,A, 2005-186567, for example). In this prior art reference, a band-shaped tag tape as a base tape on which RFID tag circuit elements are provided with a predetermined interval is fed out of a roll of a tape with RFID tags as a first roll and a print-receiving tape fed out of another roll as a second roll is bonded to the tag tape. At this time, predetermined RFID tag information created on the side of the apparatus is transmitted to the RFID tag circuit element of the tag tape and written in the IC circuit part, printing corresponding to the RFID tag information written in at that time is performed on the print-receiving tape by printing means, and thereby an RFID label with print is produced.

In general, an RFID label produced by an apparatus for producing RFID label as described in JP, A, 2005-186567 is provided in association with a management target such as an article by being affixed thereto. The RFID tag information is read from the RFID label provided at the product by a reader as described in JP, A, 2005-298100 so that information relating to the product is obtained and the product is managed.

Here, in an environment where a plurality of PC terminals is connected through a network such as LAN, a plurality of antennas is provided outside the reader main body and connected to the reader main body, for example, and each antenna may be arranged corresponding to each of the plurality of PC terminals, that is, in the vicinity of each PC, for example. In this case, RFID tag information read from the RFID label by each antenna is obtained in the reader main body through the network such as LAN and then, the corresponding information is transmitted to the PC terminal. In such a case, a switch configured to selectively connect any one of the plurality of antennas to the reader main body needs to be provided, and an operator is required to switch and operate the switch, which takes labor.

### SUMMARY OF THE INVENTION

The present invention has an object to provide an apparatus for reading an RFID tag that can reduce an operation burden on the operator and improve convenience.

### BRIEF DESCRIPTION OF THE DRAWING

FIG. 1 is a system configuration diagram illustrating an RFID tag manufacturing system provided with an apparatus for reading with an RFID tag, which is an embodiment of the present invention.

FIG. 2 is a perspective view illustrating an entire structure of the apparatus for reading with an RFID tag.

FIG. 3 is a perspective view illustrating a structure of an internal unit inside the apparatus for reading with an RFID tag. However, a loop antenna LC, which will be described later, is omitted.

FIG. 4 is a plan view illustrating a structure of an internal unit inside the apparatus for reading with an RFID tag.

FIG. 5 is an enlarged plan view schematically illustrating a detailed structure of a cartridge.

FIG. 6 is a functional block diagram illustrating a control system of the apparatus for reading with an RFID tag, which is an embodiment of the present invention.

FIG. 7A is a top view illustrating an example of an appearance of the RFID label.

FIG. 7B is a bottom view illustrating an example of an appearance of the RFID label.

FIG. 8A is a view obtained by rotating the cross sectional view by IXA-IXA′ section in FIG. 7 counterclockwise by 90°.

FIG. 8B is a view obtained by rotating the cross sectional view by IXB-IXB′ section in FIG. 7 counterclockwise by 90°.

FIG. 9 is a flowchart illustrating a control procedure executed by a control circuit.

FIG. 10 is a flowchart illustrating a detailed procedure of Step S100 shown in FIG. 9.

FIG. 11 is a flowchart illustrating a detailed procedure of Step S200 shown in FIG. 10.

FIG. 12 is a flowchart illustrating a detailed procedure of Step S400 shown in FIG. 11.

FIG. 13 is a flowchart illustrating a detailed procedure of interruption reading processing.

FIG. 14 is a flowchart illustrating a detailed procedure of Step S300 shown in FIG. 9.

FIG. 15 conceptually illustrates an example of a behavior of time sharing.

FIG. 16 illustrates an example of a table in which reading information and an identifier indicating an antenna identification result are stored in association with each other.

FIG. 17 is a schematic plan view illustrating an arrangement in which a plurality of operation terminals is connected to an apparatus main body and an antenna unit is arranged in the vicinity of each of the terminals, respectively.

### DETAILED DESCRIPTION OF THE PREFERRED EMBODIMENTS

An embodiment of the present invention will be described below referring to the attached drawings.

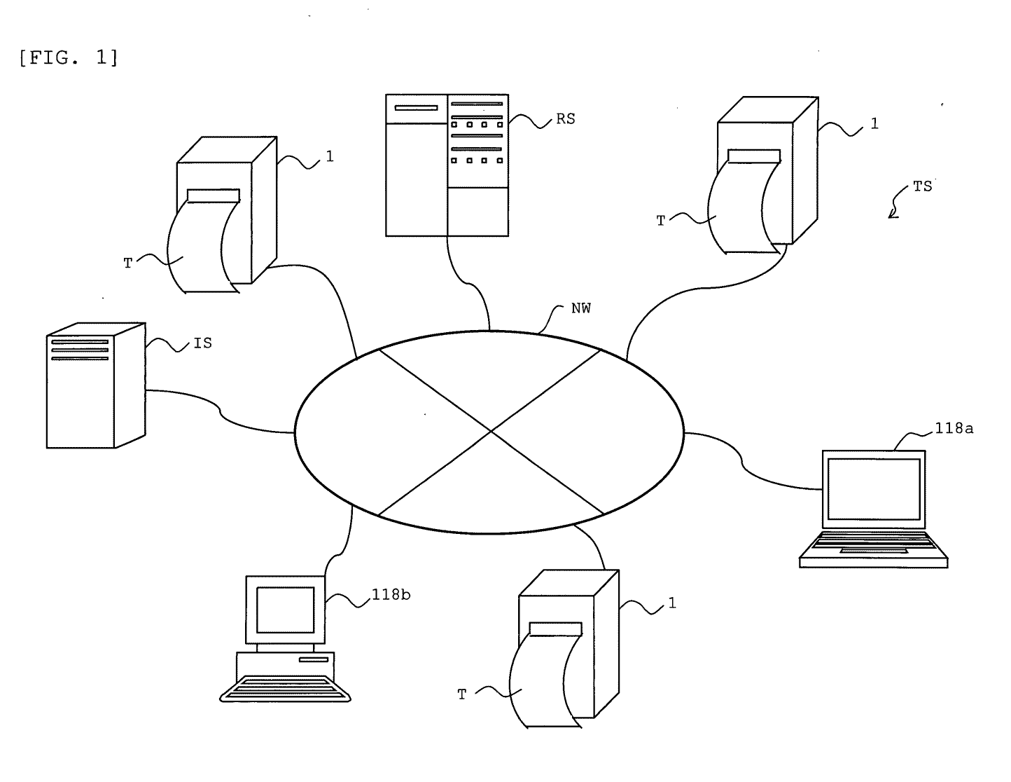

In an RFID tag manufacturing system TS shown in FIG. 1, an apparatus 1 for communicating with an RFID tag is connected to a route server RS, a plurality of information servers IS, a terminal 118a, and a general-purpose computer 118b through a wired or wireless communication line NW. The terminal 118a and the general-purpose computer 118b are collectively referred to simply as “PC 118” below as appropriate.

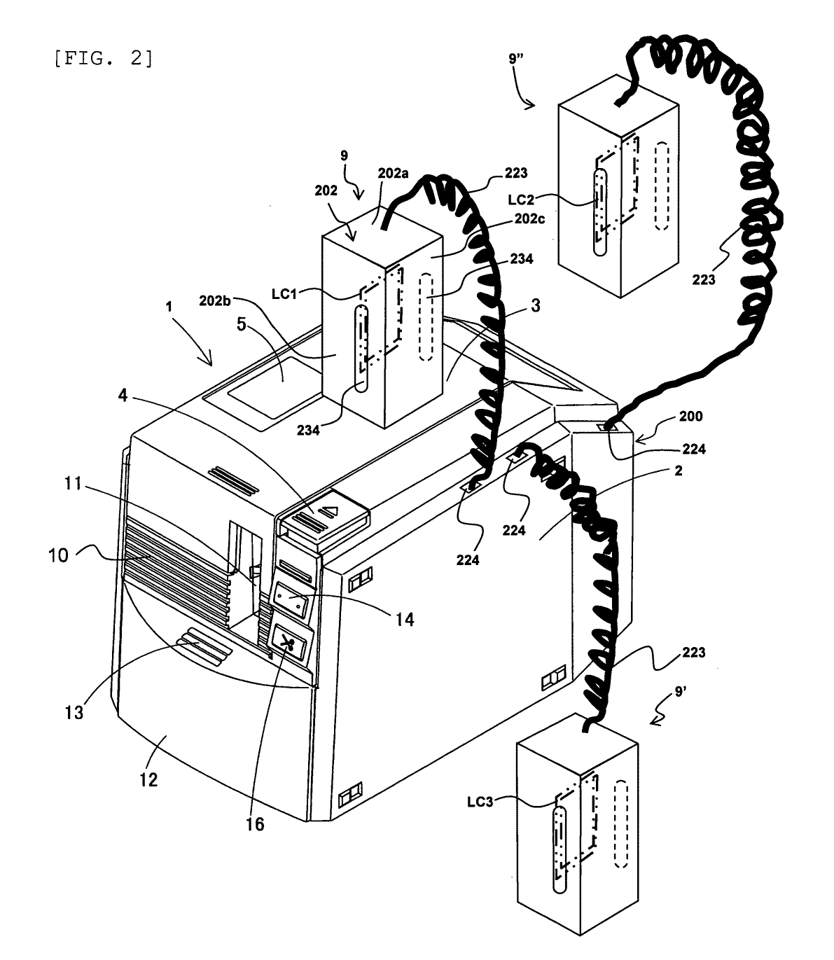

As shown in FIG. 2, the apparatus 1 for communicating with an RFID tag produces an RFID label with print using a tag medium provided with an RFID tag circuit element for label production in the apparatus and reads, that is, gets information from the RFID tag circuit element for getting information outside the apparatus on the basis of an operation from the PC 118. The apparatus 1 for communicating with an RFID tag has a label production processing mode as a writing mode configured to produce the RFID label with print and an information obtainment processing mode as a reading mode configured to read information of the RFID tag circuit element for getting information as processing modes.

The apparatus 1 for communicating with an RFID tag has an apparatus main body 2, an opening and closing lid 3, and antenna units 9, 9′ and 9″. The apparatus main body 2 has a substantially hexagonal, that is, substantially cubic housing 200 on the outline. The opening and closing lid 3 is provided on an upper face of the apparatus main body 2. The opening and closing lid 3 is capable of being opened and closed or may be configured detachable. The antenna units 9, 9′ and 9″ are detachably connected to connection ports 224 as connection portions through a cable 223. The connection ports 224 are provided at plural locations, that is, 3 locations in this example on an upper side portion of the housing 200. The antenna units 9, 9′ and 9″ can be used by an operator as a portable antenna or remote antenna.

The housing 200 of the apparatus main body 2 comprises a front wall 10 located at a front side of the apparatus (left front side in FIG. 2) and provided with a label carry-out exit 11 configured to discharge an RFID label T (which will be described later) produced inside the apparatus main body 2 to the outside and a front lid 12 provided below the label carry-out exit 11 in the front wall 10 and having its lower end rotatably supported.

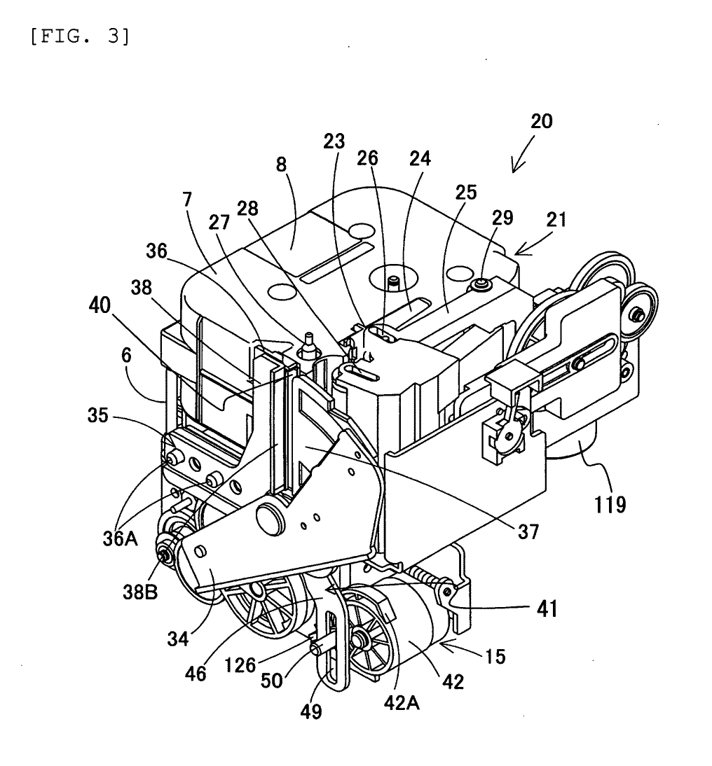

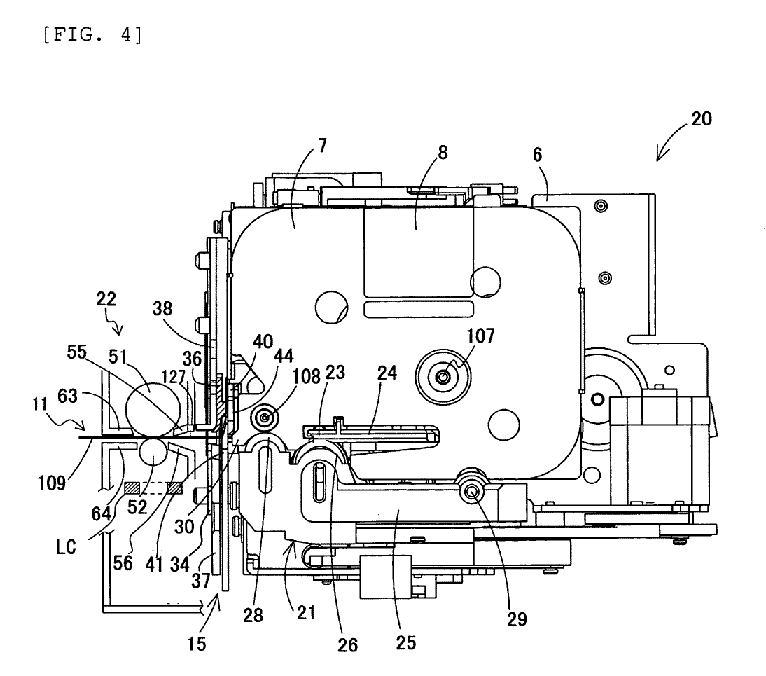

The front lid 12 is provided with a pusher portion 13, and the front lid 12 is opened forward by pushing in the pusher portion 13 from above. At one end portion of the front wall 10, a power button 14 configured to power on and off the apparatus 1 for communicating with an RFID tag and a cutter driving button 16 are provided. The cutter driving button 16 drives a cutting mechanism 15 (See FIG. 3, which will be described later) disposed in the apparatus main body 2 through a manual operation of the operator. When this button 16 is pressed, a tag label tape 109 with print (See FIG. 4, which will be described later) is cut to a desired length so as to produce the RFID label T.

The opening and closing lid 3 is pivotally and rotatably supported at an end portion on the right depth side in FIG. 2 of the apparatus main body 2 and urged in an opening direction all the time through an urging member such as a spring. When the opening and closing button 4 arranged adjacent to the opening and closing lid 3 on the upper face of the apparatus main body 2 is pressed, lock between the opening and closing lid 3 and the apparatus main body 2 is released, and the lid is opened by an action of the urging member. At a center side portion of the opening and closing lid 3, a see-through window 5 covered by a transparent cover is provided.

Each of the antenna units 9, 9′ and 9″ (hereinafter referred to as “antenna units 9” as appropriate) has a housing 202. In the housing 202, loop antennas LC1, LC2 and LC3 as apparatus antennas (conceptually shown by a virtual line in FIG. 2) configured to conduct radio communication with an RFID tag circuit element To (details will be described later) outside the apparatus 1 are provided, respectively. Each of the loop antennas LC1, LC2 and LC3 makes an access, that is, perform information reading or information writing to the RFID tag circuit element To via magnetic induction. The magnetic induction includes electromagnetic induction, magnetic coupling, and other non-contact methods conducted through the electromagnetic field.

The housing 202 in this example has a substantially rectangular solid shape, and one end of the cable 223 is connected and fixed to an upper face or lower face 202a. In this example, the end of the cable 223 is fixed to an upper face 202a. The other end of the cable 223 is detachably connected to a connection port 224 provided in the housing 200 of the apparatus main body 2 as described above. On a side face 202b and a side face 202c on the opposite side thereof in the housing 202, a gripping portion 234 configured for the operator to grip the housing 202 is provided at an appropriate position. As a result, gripping performance when the operator uses the antenna units 9 as a portable antenna can be improved.

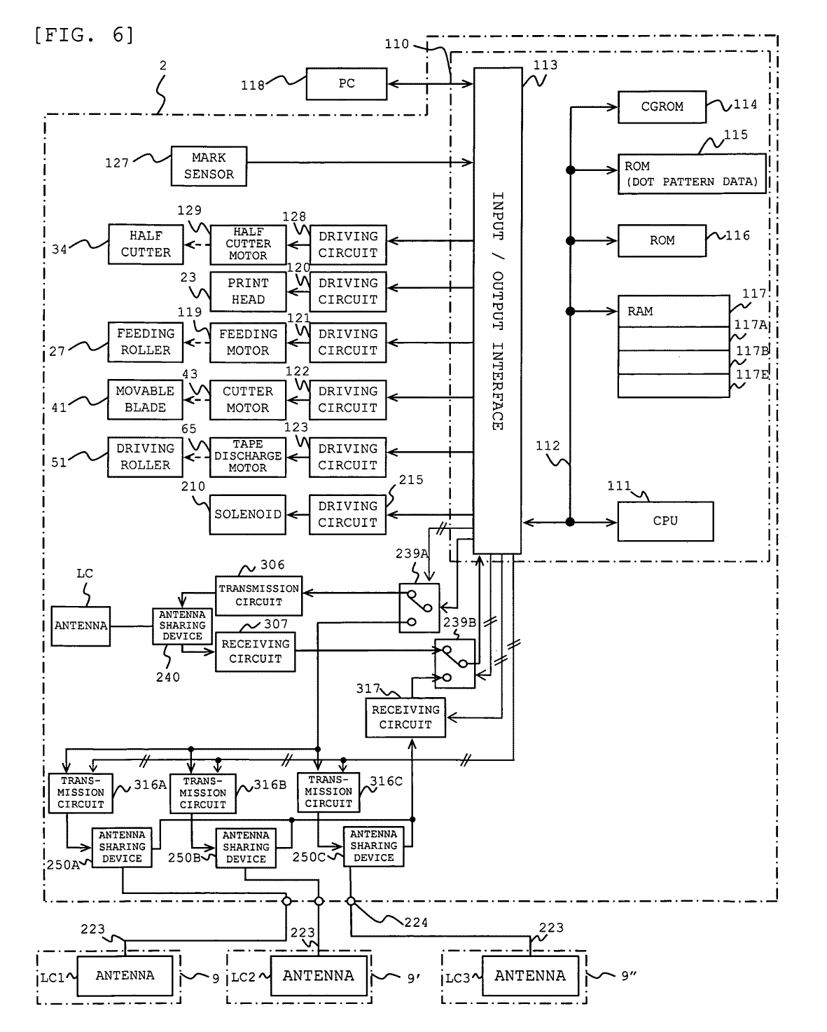

The cable 223 electrically connects the antenna units 9 and the apparatus main body 2 to each other. Through the cable 223, a signal is transmitted or received to or from transmission circuits 316A, 316B and 316C as well as a receiving circuit 317 of the apparatus main body 2 and the loop antennas LC1, LC2 and LC3 of the antenna units 9 (See FIG. 6, which will be described later).

A structure of an internal unit 20 inside the apparatus 1 is described by using FIG. 3. In FIG. 3, the internal unit 20 generally comprises a cartridge holder 6 configured to accommodate a cartridge 7, a printing mechanism 21 provided with a print head 23 as a thermal head, the cutting mechanism 15 as a cutting device 15 provided with a fixed blade 40 and a movable blade 41, and a half cut unit 35 as a half cutting device located on a downstream side in a direction along the tape feeding of the fixed blade 40 and the movable blade 41 and provided with a half cutter 34.

On an upper face of the cartridge 7, a tape identification display portion 8 that displays tape width, tape color of a base tape 101 built in the cartridge 7, for example, is provided. Also, in the cartridge holder 6, a roller holder 25 is pivotally and rotatably supported by a support shaft 29 so that switching can be made between a printing position as a contact position (see FIG. 4, which will be described later) and a release position as a separated position by a switching mechanism. At this roller holder 25, a platen roller 26 and a tape feeding roller 28 are rotatably disposed, and when the roller holder 25 is switched to the printing position, the platen roller 26 and the tape feeding roller 28 are pressed onto the print head 23 and the feeding roller 27.

The print head 23 is provided with a large number of heater elements and is mounted to a head mounting portion 24 installed upright on the cartridge holder 6.

The cutting mechanism 15 is provided with the fixed blade 40 and the movable blade 41 constructed by a metal member. A driving force of the cutter motor 43 (See FIG. 6, which will be described later) is transmitted to a shank portion 46 of the movable blade 41 through a cutter helical gear 42, a boss 50, and a long hole 49, and the movable blade is rotated, which performs a cutting operation with the fixed blade 40. This cutting state is detected by a micro switch 126 switched by an action of a cam 42A for cutter helical gear.

The half cut unit 35 has a receiver 38 and the half cutter 34 opposed to each other in arrangement, and a first guide portion 36 and a second guide portion 37 are mounted to a side plate 44 (See FIG. 4, which will be described later) by a guide fixing portion 36A. The half cutter 34 is rotated by a driving force of a half cutter motor 129 (See FIG. 6, which will be described later) around a predetermined rotation fulcrum (not shown). At an end portion of the receiver 38, a receiving face 38B is formed.

As shown in FIG. 4, the cartridge holder 6 stores the cartridge 7 so that the a width direction of the tag label tape 109 with print discharged from a tape discharge portion 30 of the cartridge 7 and further discharged from a label carry-out exit 11 should be in a perpendicular direction.

In the internal unit 20, a label discharge mechanism 22 and the loop antenna LC for label production are provided.

The loop antenna LC is provided with a communicable area on the side of an inside of the housing 200 and is configured capable of information transmission and reception with respect to the RFID tag circuit element To for label production provided in the tag label tape 109 with print.

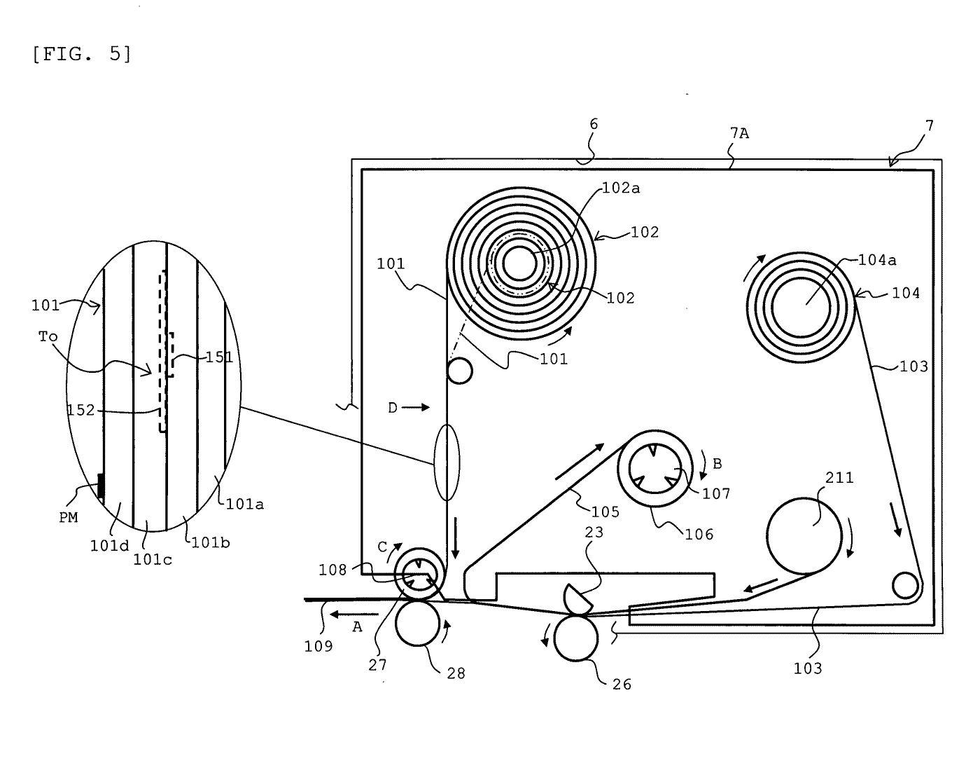

The label discharge mechanism 22 discharges the tag label tape 109 with print after it is cut in the cutting mechanism 15 from the label carry-out exit 11 (See FIG. 2). In other words, after the cutting, the tag label tape 109 with print corresponds to an RFID label T and therefore the same applies to the following. That is, the label discharge mechanism 22 comprises a driving roller 51 configured to be rotated by a driving force of a tape discharge motor 65 (See FIG. 6, which will be described later), a pressure roller 52 opposed to the driving roller 51 with the tag label tape 109 with print between them, and a mark sensor 127 configured to detect an identification mark PM (See FIG. 5, which will be described later) provided on the tag label tape 109 with print. At this time, the first guide walls 55, 56 and second guide walls 63, 64 that guide the tag label tape 109 with print to the label carry-out exit 11 and the loop antenna LC are provided inside the label carry-out exit 11. The first guide walls 55, 56 and the second guide walls 63, 64 are integrally formed, respectively, and arranged at a discharge position of the tag label tape 109 with print, that is, an RFID label T cut by the fixed blade 40 and the movable blade 41 so that they are separated from each other with a predetermined interval.

A feeding roller driving shaft as a feeding device 108 and a ribbon take-up roller driving shaft 107 give a feeding driving force of the tag label tape 109 with print and an ink ribbon 105 (which will be described later), respectively, and are rotated and driven in conjunction with each other.

As shown in FIG. 5, the cartridge 7 has a housing 7A, a first roll 102, a second roll 104, a ribbon-supply-side roll 211, a ribbon take-up roller 106, and the feeding roller 27. The first roll 102 is arranged inside the housing 7A and the base tape 101 in the band state is wound around the first roll 102. A transparent cover film 103 having substantially the same width as that of the base tape 101 is wound around the second roll 104. The ribbon-supply-side roll 211 feeds out the ink ribbon 105. The ribbon take-up roller 106 winds up the ink ribbon 105 after printing. The feeding roller 27 is rotatably supported in the vicinity of the tape discharge portion 30 of the cartridge 7. The base tape 101 and the tag label tape 109 with print in which the cover film 103 is bonded to the base tape 101 include a tag medium. Actually, the first roll 102 is wound in a swirl state but shown concentrically in the figure for simplification. Actually, the second roll 104 actually, it is wound in a swirl state but shown concentrically in the figure for simplification. The ink ribbon 105 is a thermal transfer ribbon, however, it is not needed when the print-receiving tape is a thermal tape.

The feeding roller 27 presses and bonds the base tape 101 and the cover film 103 together so as to have the tag label tape 109 with print and feeds the tape in a direction shown by an arrow A in FIG. 5. The feeding roller also functions as a tape feeding roller.

In the first roll 102, the base tape 101 in which a plurality of RFID tag circuit elements To for label production is sequentially formed in a longitudinal direction with a predetermined equal interval is wound around a reel member 102a. The base tape 101 has a four-layered structure (See the partially enlarged view in FIG. 5) in this example and is constructed by lamination in the order of an adhesive layer 101a made of an appropriate adhesive, a colored base film 101b made of polyethylene terephthalate (PET), an adhesive layer 101c made of an appropriate adhesive, and a separation sheet as separation material 101d from the side wound inside (right side in FIG. 5) toward the opposite side (left side in FIG. 5).

On a back side of the base film 101b (left side in FIG. 5), a tag antenna 152 constructed in the loop-coil shape for transmission and reception of information is provided integrally in this embodiment, an IC circuit part 151 connected to it and storing information is formed, and the RFID tag circuit element To for label production is included by them.

On a front side of the base film 101b (right side in FIG. 5), the adhesive layer 101a that bonds the cover film 103 thereto later is formed, while on the back side of the base film 101b (left side in FIG. 5), the separation sheet 101d is bonded to the base film 101b by the adhesive layer 101c provided so as to include the RFID tag circuit element To for label production.

Note that, the separation sheet 101d, when the RFID label T finally completed in the label state is to be affixed to a predetermined article, enables adhesion to the article by the adhesive layer 101c through separation of the separation sheet. Also, on the surface of the separation sheet 101d, at a predetermined position corresponding to each RFID tag circuit element To for label production, predetermined identification mark PM for feeding control as identification marks is painted in black in this embodiment. In this embodiment, the identification mark PM is painted at positions on the further front from a distal end of the tag antenna 152 in the front side in the feeding direction. Or, it may be a drilled hole penetrating the base tape 101 by laser machining or it may be a Thomson type machined hole.

The second roll 104 has the cover film 103 wound around a reel member 104a. In the cover film 103 fed out of the second roll 104, the ink ribbon 105 arranged on its back face side, that is, the side to be bonded to the base tape 101 and driven by the ribbon-supply-side roll 211 and the ribbon take-up roller 106 is brought into contact with the back face of the cover film 103 by being pressed by the print head 23.

The ribbon take-up roller 106 and the feeding roller 27 are rotated and driven, respectively, in conjunction by a driving force of a feeding motor 119 (See FIG. 3 and FIG. 6, which will be described later), which is a pulse motor, for example, provided outside the cartridge 7, transmitted to the ribbon take-up roller driving shaft 107 and the feeding roller driving shaft 108 through a gear mechanism, not shown. The print head 23 is arranged on the upstream side in the feeding direction of the cover film 103 than the feeding roller 27.

In the above construction, the base tape 101 fed out of the first roll 102 is supplied to the feeding roller 27. On the other hand, as for the cover film 103 fed out of the second roll 104, the ink ribbon 105 arranged on its back face side, that is, the side bonded to the base tape 101 and driven by the ribbon-supply-side roll 211 and the ribbon take-up roller 106 is pressed by the print head 23 and brought into contact with the back face of the cover film 103.

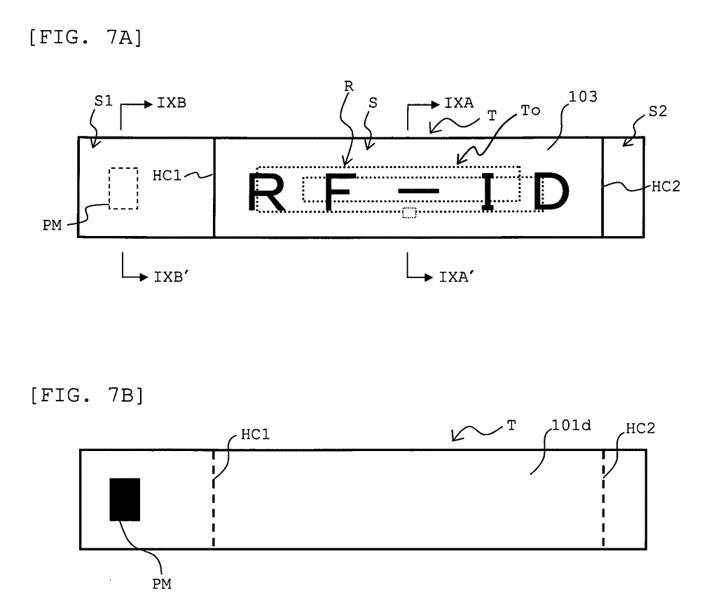

When the cartridge 7 is attached to the cartridge holder 6 and the roller holder 25 is moved from the release position to the print position, the cover film 103 and the ink ribbon 105 are held between the print head 23 and the platen roller 26, and the base tape 101 and the cover film 103 are held between the feeding roller 27 and the tape feeding roller 28. Then, the ribbon take-up roller 106 and the feeding roller 27 are rotated and driven by the driving force of the feeding motor 119 in a direction shown by an arrow B and an arrow C in FIG. 5, respectively, in synchronization with each other. At this time, the feeding roller driving shaft 108, the tape feeding roller 28 and the platen roller 26 are connected through the gear mechanism (not shown), and with the driving of the feeding roller driving shaft 108, the feeding roller 27, the tape feeding roller 28, and the platen roller 26 are rotated, and the base tape 101 is fed out of the first roll 102 and supplied to the feeding roller 27 as described above. On the other hand, the cover film 103 is fed out of the second roll 104, and the plurality of heater elements of the print head 23 is electrified by a print-head driving circuit 120 (See FIG. 6, which will be described later). As a result, a print character string R (See FIG. 7, which will be described later) corresponding to the RFID tag circuit element To for label production on the base tape 101 to be bonded thereto is printed on the back face of the cover film 103. Then, the base tape 101 and the cover film 103 on which the printing has been finished are bonded together by the feeding roller 27 and the tape feeding roller 28 to be integrated and formed as the tag label tape 109 with print and fed out of the cartridge 7 through the tape discharge portion 30 (See FIG. 4). The ink ribbon 105 finished with printing on the cover film 103 is taken up by the ribbon take-up roller 106 by driving of the ribbon take-up roller driving shaft 107.

After information reading or writing is carried out for the RFID tag circuit element To for label production by the loop antenna LC to the tag label tape 109 with print produced by bonding as above, the tag label tape 109 with print is cut off automatically or by the cutting mechanism 15 by operating the cutter driving button 16 (See FIG. 2) so that the RFID label T is produced. This RFID label T is further discharged from the label carry-out exit 11 (See FIGS. 2 and 4) by the label discharge mechanism 22.

A control system of the apparatus 1 is described by using FIG. 6. In FIG. 6, a control circuit 110 is arranged on a control board (not shown) of the apparatus 1 for communicating with an RFID tag.

In the control circuit 110, a CPU 111 that controls each equipment, an input/output interface 113 connected to the CPU 111 through a data bus 112, a CGROM 114, ROMs 115, 116, and a RAM 117 are provided.

In the ROM 116, a print driving control program for driving the print head 23, the feeding motor 119, and the tape discharge motor 65 by reading data of a print buffer in accordance with an operation input signal input from the PC 118, a cutting driving control program for feeding the tag label tape 109 with print to the cut position by driving the feeding motor 119 when printing is finished and cutting the tag label tape 109 with print by driving the cutter motor 43, a tape discharge program for forcedly discharging the tag label tape 109 with print which has been cut from the label carry-out exit 11 by driving the tape discharge motor 65, a transmission program for creating access information such as an inquiry signal and a writing signal to the RFID tag circuit element To for label production or information obtainment and outputting it to the transmission circuit, a receiving program for processing a response signal input from the receiving circuit, and other various programs required for control of the apparatus 1 for communicating with an RFID tag are stored. The CPU 111 executes various calculations on the basis of the various programs stored in the ROM 116.

In the RAM 117, a text memory 117A, a print buffer 117B, a parameter storage area 117E are provided. In the text memory 117A, document data input from the PC 118 is stored. In the print buffer 117B, the dot patterns for print such as a plurality of characters and symbols and applied pulse number, which is an energy amount forming each dot, are stored as the dot pattern data, and the print head 23 carries out dot printing according to the dot pattern data stored in this print buffer 117B. In the parameter storage area 117E, various calculation data, tag identification information (tag ID) of the RFID tag circuit element To (described above) for information obtainment when information reading, that is, obtainment is carried out are stored.

To the input/output interface 113, the PC 118, the print-head driving circuit 120 that drives the print head 23, a feeding motor driving circuit 121 that drives the feeding motor 119, a cutter motor driving circuit 122 that drives the cutter motor 43, a half-cutter motor driving circuit 128 that drives the half-cutter motor 129, a tape discharge motor driving circuit 123 that drives the tape discharge motor 65, the mark sensor 127 that detects the identification mark PM, and switching circuits 239A, 239B are connected.

To the switching circuit 239A, a single transmission circuit 306 relating to the antenna LC and three transmission circuits 316A, 316B and 316C as an information creating devices relating to the antennas LC1, LC2 and LC3 are selectively connected. Namely, the switching circuit 239A is capable of being switched to any one of the single transmission circuit 306 and three transmission circuits 316A, 316B, 316C. The transmission circuit 306 generates a carrier wave for making an access, that is, reading or writing to the RFID tag circuit element To for label production through the loop antenna LC and outputs an interrogation wave by modulating the carrier wave on the basis of a control signal (not shown) input from the control circuit 110. The transmission circuits 316A, 316B and 316C generate and output an interrogation wave to the loop antennas LC1, LC2 and LC3, respectively, by modulating the carrier wave for making an access, that is, reading to the RFID tag circuit element To for information obtainment, that is, common carrier wave substantially at the same timing (See Step S310 and Step S330, which will be described later) on the basis of a control signal (See the illustration) input individually from the control circuit 110, respectively. Namely, the transmission circuits 316A, 316B, and 316C functions as carrier wave modulating device.

To the switching circuit 239B, a single receiving circuit 307 relating to the loop antenna LC and a single receiving circuit 317 as an information processing device relating to the antennas LC1, LC2 and LC3 are selectively connected. Namely, the switching circuit 239B is capable of being switched to any one of the single receiving circuit 307 and the single receiving circuit 317 are. The receiving circuit 307 demodulates a response wave as a response signal received from the RFID tag circuit element To for label production through the loop antenna LC on the basis of a control signal (not shown) input from the control circuit 110 and outputs it to the control circuit 110. The receiving circuit 317 demodulates a response wave as a response signal received from the RFID tag circuit element To for information obtainment through the loop antennas LC1, LC2 and LC3 on the basis of a control signal (See the illustration) input from the control circuit 110 and outputs it to the control circuit 110.

Then, the switching circuits 239A, 239B are switched in conjunction with each other on the basis of the control signal form the control circuit 110. Specifically, if the writing mode is selected as the processing mode in the control circuit 110, the input/output interface 113 is connected to the transmission circuit 306 and the receiving circuit 307 relating to the loop antenna LC. If the reading mode is selected as the processing mode, the input/output interface 113 is connected to the transmission circuits 316A, 316B and 316C and the receiving circuit 317 relating to the loop antennas LC1, LC2 and LC3.

The loop antenna LC is connected to the transmission circuit 306 and the receiving circuit 307 through an antenna sharing device 240. The loop antennas LC1, LC2 and LC3 are connected to the transmission circuits 316A, 316B and 316C and the receiving circuit 317 through the cable 223 and antenna sharing devices 250A, 250B and 250C, respectively.

In a control system centering around the control circuit 110 as above, if character data is input through the PC 118, the text as document data is sequentially stored in the text memory 117A, the print head 23 is driven through the driving circuit 120, each heater element is selectively heated and driven in response to a print dot for one line so as to print the dot pattern data stored in the print buffer 117B, and the feeding motor 119 carries out feeding control of the tape through the driving circuit 121 in synchronization therewith. Also, the transmission circuit 306 or the transmission circuits 316A, 316B and 316C carries out modulation control of the carrier wave on the basis of the control signal from the control circuit 110 so as to output an interrogation wave, and the receiving circuit 307 or the receiving circuit 317 carries out processing of a signal demodulated on the basis of the control signal from the control circuit 110.

As described above, the RFID tag circuit element To for label production or information obtainment has the loop antenna 152 that carries out signal transmission and reception contactlessly by magnetic induction with the loop antenna LC or the loop antennas LC1 to LC3 on the side of the apparatus 1 for communicating with an RFID tag and the IC circuit part 151 connected to the loop antenna 152.

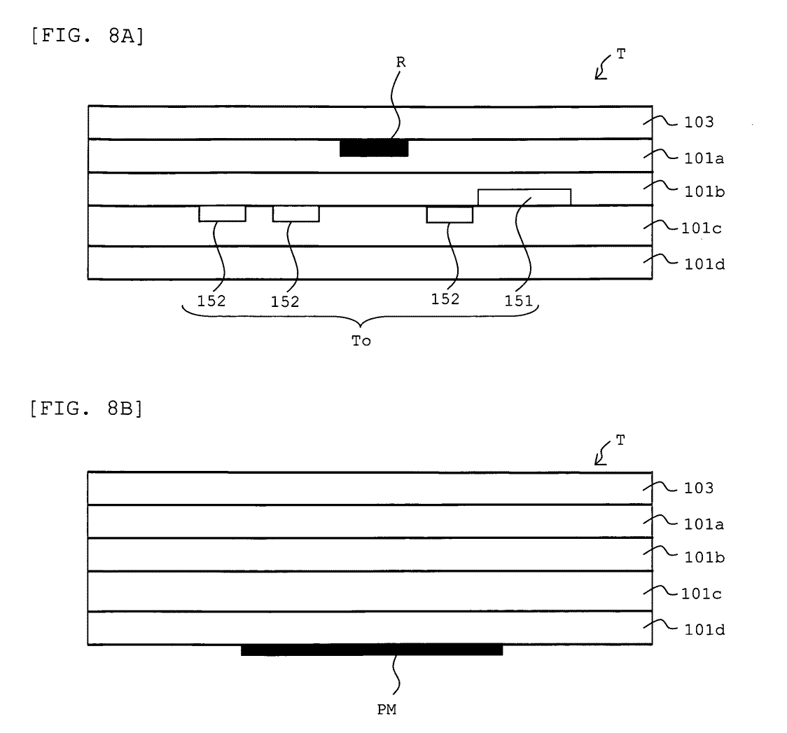

As shown in FIGS. 7A, 7B, 8A and 8B, the RFID label T is in the five-layered structure in which the cover film 103 is added to the four-layered structure shown in FIG. 5 as described above, and the cover film 103, the adhesive layer 101a, the base film 101b, the adhesive layer 101c, and the separation sheet 101d include the five layers from the side of the cover film 103 (upper side in FIG. 8) to the opposite side (lower side in FIG. 8). The RFID tag circuit element To for label production including the loop antenna 152 provided on the back side of the base film 101b as described above is provided in the base film 101b and the adhesive layer 101c, and a label print character string R corresponding to stored information of the RFID tag circuit element To for label production is printed on the back face of the cover film 103. As an example of the print character string R, characters of “RF-ID” indicating a type of the RFID label T is shown.

On the cover film 103, the adhesive layer 101a, the base film 101b, and the adhesive layer 101c, at least one half-cut line HC as a half-cut portion are formed by the half cutter 34 substantially along the tape width direction as described above. In this example, two lines of a front half-cut line HC1 and a rear half-cut line HC2 are shown. A area held between the half-cut lines HC1, HC2 in the cover film 103 becomes a print area S on which the label print character string R is to be printed, and an area on both sides in the tape longitudinal direction having the half-cut lines HC1, HC2 between them from the print area S becomes a front margin area S1 and a rear margin area S2.

In the apparatus 1 for communicating with an RFID tag with the above basic configuration, the writing mode for producing the RFID label T using the RFID tag circuit element To for label production in the housing 200 and the reading mode for information reading, that is, obtainment from the RFID tag circuit element for information obtainment outside the apparatus 1 can be executed as described above. That is, in the writing mode, the base tape 101 provided with the RFID tag circuit element To for label production is fed by the feeding roller 27, information transmission and reception is carried out with respect to the RFID tag circuit element To for label production through the loop antenna LC, and the RFID label T is produced. On the other hand, in the reading mode, the information transmission and reception is carried out with the RFID tag circuit element To for information obtainment located outside the housing 200 through the loop antennas LC1, LC2 and LC3 for information obtainment provided in the antenna units 9, 9′ and 9″ so that predetermined RFID tag information is read and obtained.

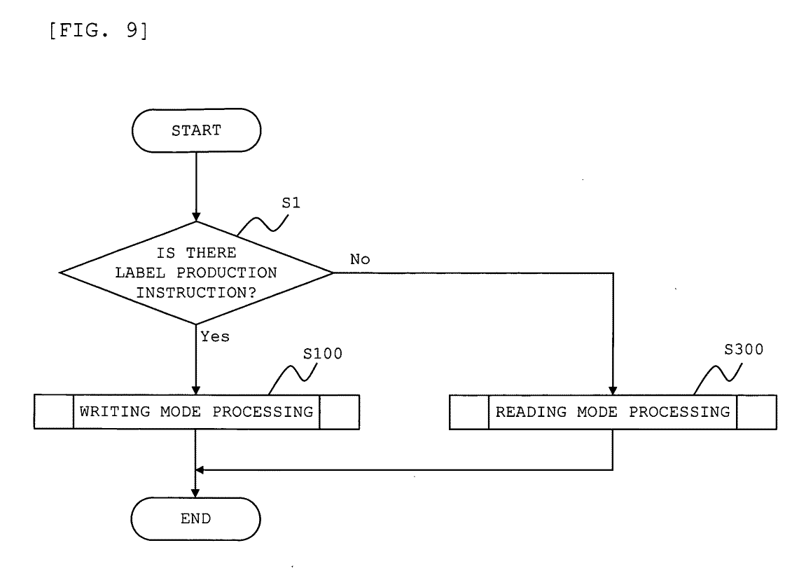

A control procedure executed by the control circuit 110 is described by using FIG. 9. This flow is started when the apparatus 1 for communicating with an RFID tag is powered on, for example. The stage corresponds to “START position”.

In FIG. 9, first, at Step S1, it is determined if a label production instruction has been input from the PC 118 through the input/output interface 113 or not. If the label production instruction has been input, the determination at Step S1 is satisfied, and the routine goes to the writing mode processing at Step S100, while if the label production has not been instructed, the determination at Step S1 is not satisfied, and the routine goes to the reading mode processing at Step S300. The Step S300 functions as a mode switching portion.

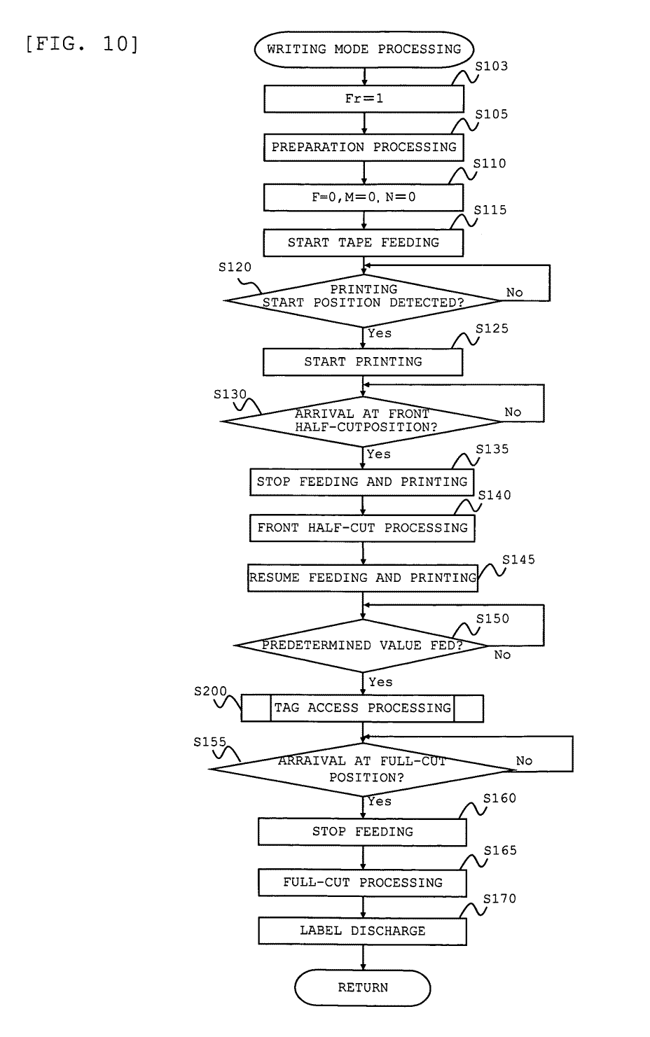

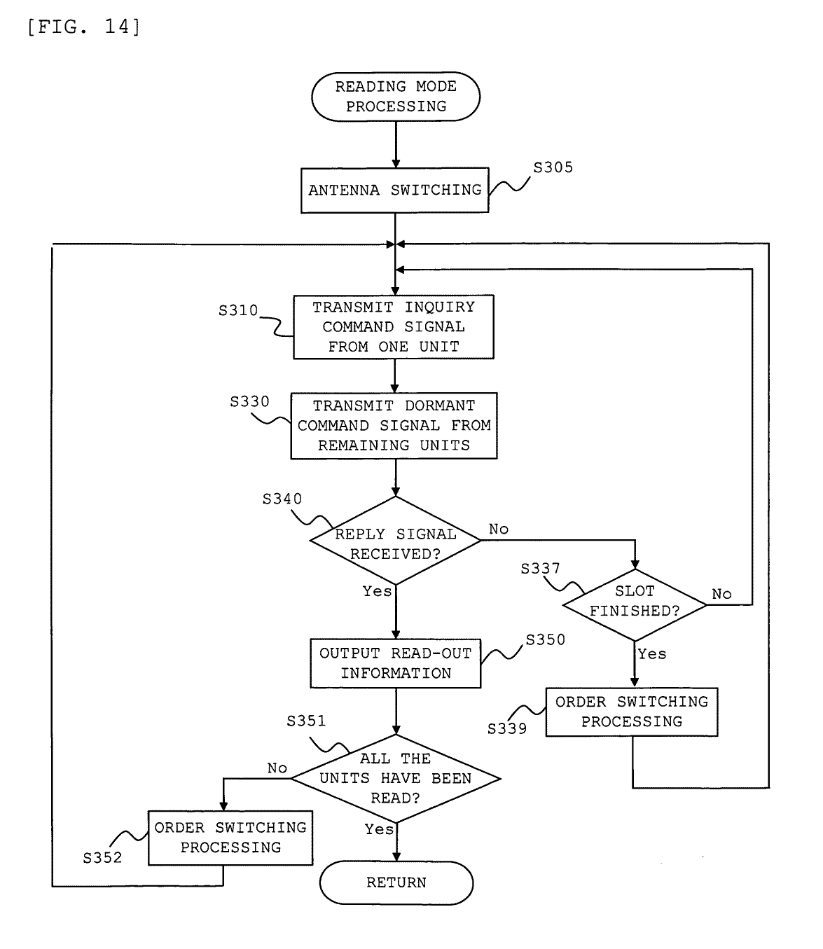

The writing mode processing is mainly an operation mode in which the RFID tag information is transmitted to the RFID tag circuit element To for label production and written in the IC circuit part 151 so that the RFID label T is produced (See FIG. 10, which will be described later). In a variation described later in which the label is produced using the read-only RFID tag circuit element To, the writing mode processing includes a case that the RFID tag information is read from the read-only RFID tag circuit element To in which the predetermined RFID tag information is unrewritably stored and held in advance, and a printing corresponding the tag information is carried out so as to produce the RFID label T. The reading mode processing is an operation mode in which the apparatus 1 for communicating with an RFID tag is used as a reader that reads the RFID tag information from the RFID tag circuit element To for information obtainment provided in the RFID label T outside the apparatus (See FIG. 14, which will be described later).

After Step S100 or Step S300 is executed, this flow is finished.

A detailed procedure of the writing mode processing at Step S100 is described by using FIG. 10.

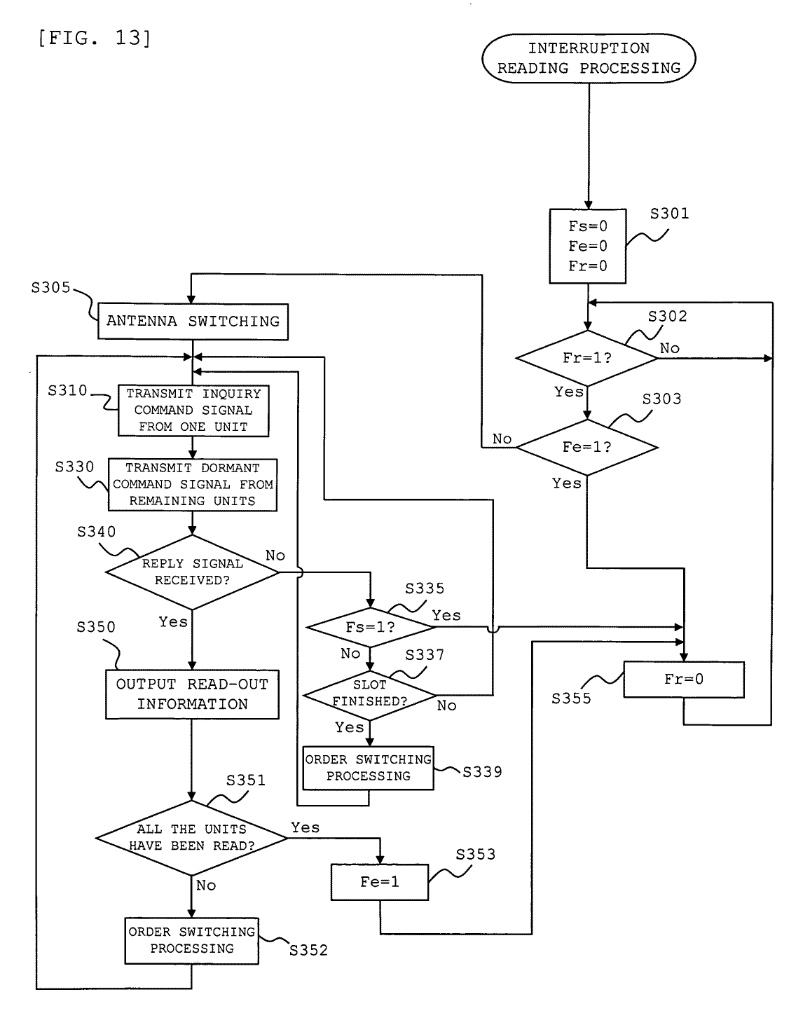

First, at Step S103, a flag Fr=1 to start execution of interruption reading processing described in FIG. 13, which will be described later, is set.

Subsequently, at Step S105, preparation processing is executed in which printing data, communication data with the RFID tag circuit element To, front and rear half cut positions and full-cut position are set on the basis of an operation signal from the PC 118.

Subsequently, at Step S110, in communication from the loop antenna LC to the RFID tag circuit element To for label production, variables M, N that count the number of times, that is, access retry number of times to make communication retries if there is no response from the RFID tag circuit element To and a flag F indicating if the communication was successful or not are initialized to zero.

After that, the routine goes to Step S115, where a control signal is output to the feeding motor driving circuit 121 through the input/output interface 113 so as to rotate and drive the feeding roller 27 and the ribbon take-up roller 106 by the driving force of the feeding motor 121. Moreover, a control signal is output to the tape discharge motor 65 through the tape discharge motor driving circuit 123 so as to rotate and drive the driving roller 51. As a result, the base tape 101 is fed out of the first roll 102 and supplied to the feeding roller 27, while the cover film 103 is fed out of the second roll 104, the base tape 101 and the cover film 103 are bonded by the feeding roller 27 and the tape feeding roller 28 to be integrated and formed as the tag label tape 109 with print and further fed from a direction outside the cartridge 7 to a direction outside the apparatus 1 for communicating with an RFID tag.

After that, at Step S120, on the basis of the detection signal of the mark sensor 127 input through the input/output interface 113, it is determined if the identification mark PM of the base tape 101 has been detected or not. In other words, if the cover film 103 has reached a print start position by the print head 23 or not is determined. The determination is not satisfied till the identification mark PM is detected and this procedure is repeated, and if detected, the determination is satisfied and the routine goes to the subsequent Step S125.

At Step S125, a control signal is output to the print-head driving circuit 120 through the input/output interface 113, the print head 23 is electrified, and printing of the label print character string R such as the characters, symbols, and barcodes corresponding to the printing data created at Step S105 is started on the above-described print area S in the cover film 103. The print area S is an area to be bonded substantially on a back face of the RFID tag circuit element To for label production arranged with an equal interval at a predetermined pitch on the base tape 101.

After that, at Step S130, it is determined if the tag label tape 109 with print has been fed to a front half-cut position set at the previous Step S105 or not. In other words, it is determined if the tag label tape 109 with print has reached a position where the half cutter 34 of the half-cut unit 35 is opposed to a front half-cut line HC1 set at Step S105 or not. The determination at this time can be made by detecting a feeding distance after the identification mark PM of the base tape 101 is detected by a predetermined known method at Step S120, for example. The known method is performed by counting the number of pulses output by the feeding motor driving circuit 121 driving the feeding motor 119, which is a pulse motor. The determination is not satisfied till the front half-cut position is reached and this procedure is repeated, and if reached, the determination is satisfied, and the routine goes to the subsequent Step S135.

At Step S135, a control signal is output to the feeding motor driving circuit 121 and the tape discharge motor driving circuit 123 through the input/output interface 113 so as to stop driving of the feeding motor 119 and the tape discharge motor 65 and to stop rotation of the feeding roller 27, the ribbon take-up roller 106, and the driving roller 51. As a result, while the tag label tape 109 with print fed out of the cartridge 7 is moved in the discharge direction, in a state where the half cutter 34 of the half-cut unit 35 is opposed to the front half-cut line HC1 set at Step S105, feeding-out of the base tape 101 from the first roll 102, feeding-out of the cover film 103 from the second roll 104, and feeding of the tag label tape 109 with print are stopped. At this time, a control signal is also output to the print-head driving circuit 120 through the input/output interface 113 so as to stop electricity to the print head 23 and to stop the printing of the label print character string R, that is, the printing is interrupted.

After that, at Step S140, a control signal is output to the half-cutter motor driving circuit 128 through the input/output interface 113 so as to drive the half-cutter motor 129, to rotate the half cutter 34, and to carry out the front half-cut processing of cutting off the cover film 103, the adhesive layer 101a, the base film 101b, and the adhesive layer 101c of the tag label tape 109 with print so as to form the front half-cut line HC1.

Then, the routine goes to Step S145, where the feeding roller 27, the ribbon take-up roller 106, and the driving roller 51 are rotated and driven similarly to Step S115 so as to resume the feeding of the tag label tape 109 with print, and the printing of the label print character string R is resumed by electrifying the print head 23 similarly to Step S125.

After that, at Step S150, it is determined whether or not the tag label tape 109 with print during feeding has been fed by a predetermined value. The predetermined value corresponds to a feeding distance by which the RFID tag circuit element To for label production bonded with the cover film 103 to which the corresponding printing has been performed reaches the loop antenna LC, for example. The feeding distance determination at this time can be made only by counting the number of pulses output by the feeding motor driving circuit 121 that drives the feeding motor 119 as a pulse motor similarly to Step S130.

At the subsequent Step S200, tag access processing is carried out. That is, if the feeding has been done to a communication position of the RFID tag circuit element To for label production, the feeding and printing are stopped and information transmission and reception is carried out. The communication position is a position where the RFID tag circuit element To is opposed to the loop antenna LC.

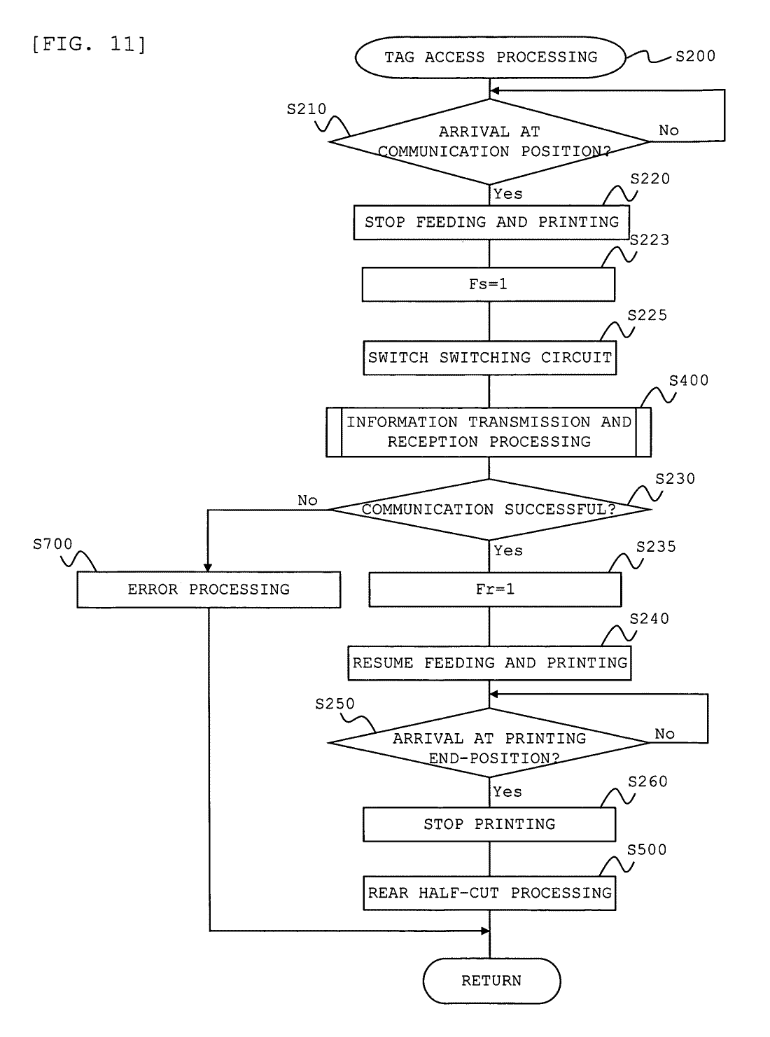

Then, the feeding and printing are resumed so as to complete the print, and the feeding is further continued and stopped at the rear half-cut position, where the rear half-cut line HC2 is formed (See FIG. 11, which will be described later).

When Step S200 is finished as above, the routine goes to Step S155. At this time, at Step S200, the feeding of the tag label tape 109 with print has been resumed as will be described later. At Step S155, it is determined if the tag label tape 109 with print has been fed to the above-described full-cut position or not. In other words, it is determined if the tag label tape 109 with print has reached the position where the movable blade 41 of the cutting mechanism 15 is opposed to the cutting line CL set at Step S105 or not. The determination at this time may be also made by detecting the feeding distance after the identification mark PM of the base tape 101 is detected at Step S120 by a predetermined known method, for example, similarly to the above. The known method is performed by counting the number of pulses output by the feeding motor driving circuit 121 driving the feeding motor 119, which is a pulse motor. The determination is not satisfied till the full-cut position is reached and this procedure is repeated, and if reached, the determination is satisfied and the routine goes to the subsequent Step S160.

At Step S160, similarly to Step S135, the rotation of the feeding roller 27, the ribbon take-up roller 106, and the driving roller 51 is stopped, and the feeding of the tag label tape 109 with print is stopped. As a result, the feeding-out of the base tape 101 from the first roll 102, the feeding-out of the cover film 103 from the second roll 104, and the feeding of the tag label tape 109 with print are stopped in a state where the movable blade 41 of the cutting mechanism 15 is opposed to the cutting line CL set at Step S105.

After that, a control signal is output to the cutter motor driving circuit 122 at Step S165 so as to drive the cutter motor 43, to rotate the movable blade 41 of the cutting mechanism 15, and to carry out the full cut processing of cutting, that is, separating all the cover film 103, the adhesive layer 101a, the base film 101b, the adhesive layer 101c, and the separation sheet 101d of the tag label tape 109 with print so as to form the cutting line CL. The label-shaped RFID label T, which is separated by cutting using the cutting mechanism 15 from the tag label tape 109 with print and in which the RFID tag information is written in the RFID tag circuit element To and desired printing corresponding thereto is performed, is produced.

After that, the routine goes to Step S170, where a control signal is output to the tape discharge motor driving circuit 123 through the input/output interface 113 so as to resume the driving of the tape discharge motor 65 and to rotate the driving roller 51. As a result, the feeding by the driving roller 51 is resumed, the RFID label T produced in the label shape at Step S165 is fed toward the label carry-out exit 11 and discharged through the label carry-out exit 11 to outside the apparatus 1 for communicating with an RFID tag, and this flow is finished.

A detailed procedure of the tag access processing of the above-described Step S200 is described by using FIG. 11.

First, at Step S210, it is determined if the tag label tape 109 with print has been fed to the above-described communication position with the loop antenna LC or not. The determination at this time may be also made by detecting the feeding distance after the identification mark PM of the base tape 101 is detected at Step S120 by a predetermined known method, for example, similarly to Step S130 in the above-described FIG. 10. The determination is not satisfied till the communication position is reached and this procedure is repeated, and if reached, the determination is satisfied and the routine goes to the subsequent Step S220.

At Step S220, similarly to Step S135, the rotation of the feeding roller 27, the ribbon take-up roller 106, and the driving roller 51 is stopped, and the feeding of the tag label tape 109 with print is stopped in a state where loop antenna LC is substantially opposed to the RFID tag circuit element To for label production. Also, electricity to the print head 23 is stopped so as to stop, that is, to interrupt the printing of the label print character string R.

Then, the routine goes to Step S223, where a flag Fs indicating if the communication position has been reached or not is set to one according to a determination result at Step S210. As a result, interruption reading processing is interrupted once as will be described later.

Then, at Step S225, a control signal is output to the switching circuits 239A, 239B so as to switch the switching circuits 239A, 239B, and the transmission circuit 306 and the receiving circuit 307 are connected to the input/output interface 113.

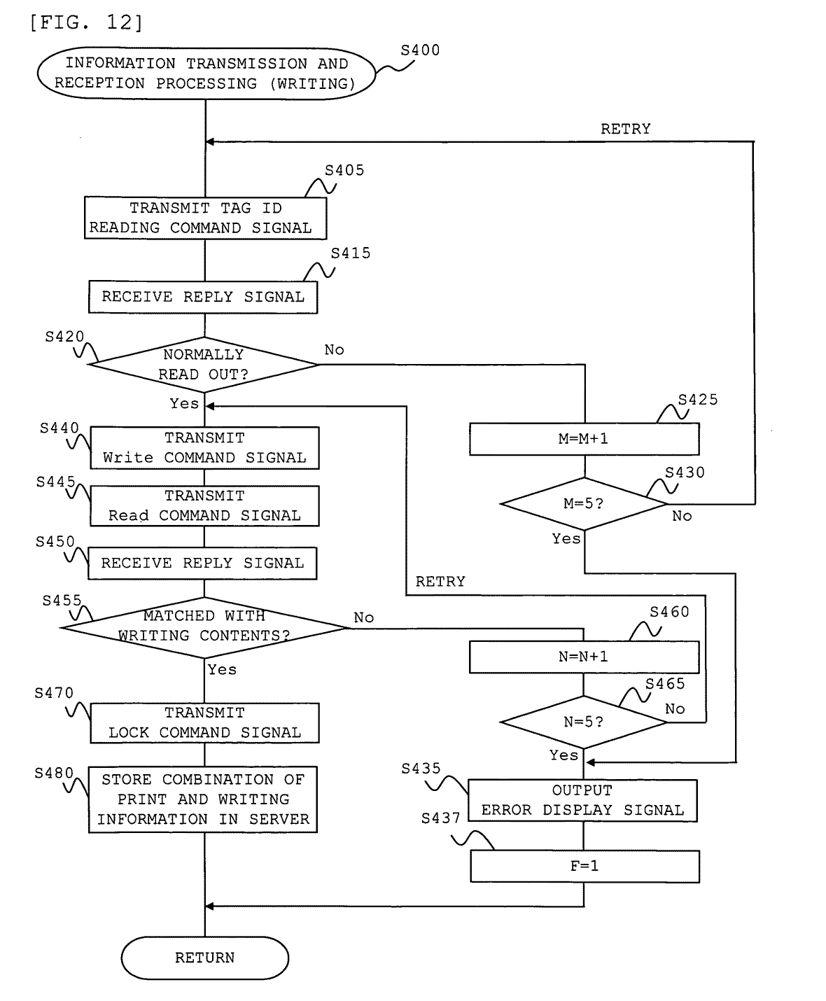

After that, the routine goes to Step S400, where information transmission and reception is carried out between the antenna LC and the RFID tag circuit element To for label production via radio communication, and information transmission and reception processing in which the information created at Step S105 in FIG. 10 is written in the IC circuit part 151 of the RFID tag circuit element To is carried out (for details, see FIG. 12, which will be described later). In a variation using the read-only RFID tag circuit element To, which will be described later, the information stored in the IC circuit part in advance is read in the information transmission and reception processing.

Then, the routine goes to Step S230, where it is determined if the information transmission and reception is successful or not at Step S400. Specifically, since it should be the flag F=1 if the communication failed at Step S400 (See Step S437 in FIG. 12, which will be described later), it is determined if F=0 or not.

If it is F=1, the determination is not satisfied, but the communication to the RFID tag circuit element To for label production is considered to fail, and the routine goes to Step S700, where error processing to notify the communication failure to the operator on a label is executed, and this routine is finished. The error processing is performed by printing another mode print character string R′ such as characters of “NG” corresponding to the communication error, for example.

On the other hand, if it is F=0, the determination is satisfied, the communication to the RFID tag circuit element To for label production is considered to be successful, and the routine goes to Step S235.

At Step S235, the flag Fr=1 to start execution of the interruption reading processing is set. As a result, the interruption reading processing interrupted once as above is started again.

After that, at Step S240, similarly to Step S145 in FIG. 10, the feeding roller 27, the ribbon take-up roller 106, and the driving roller 51 are rotated and driven so as to resume the feeding of the tag label tape 109 with print, and printing of the label print character string R is also resumed by electrifying the print head 23.

After that, the routine goes to Step S250, where it is determined whether or not the tag label tape 109 with print has been fed to the above-described printing end position. The printing end position is calculated at Step S105 in FIG. 10. The determination at this time may be also made by detecting the feeding distance after the identification mark PM of the base tape 101 is detected at Step S120 by a predetermined known method, for example, similarly to the above. The determination is not satisfied till the printing end position is reached and this procedure is repeated, and if reached, the determination is satisfied and the routine goes to the subsequent Step S260.

At Step S260, similarly to Step S135 in FIG. 10, electricity to the print head 23 is stopped, and the printing of the label print character string R is stopped. As a result, the printing of the label print character string R on the print area S is completed.

After that, the routine goes to Step S500, where the feeding to the predetermined rear half-cut position is carried out and then, the rear half-cut processing of forming the rear half-cut line HC2 by the half cutter 34 of the half cut unit 35 is carried out. Then, this routine is finished.

A detailed procedure of the above-described Step S400 is described by using FIG. 12. In this example, in the above-described information writing and information reading, the information writing will be described as an example.

In FIG. 12, first, at Step S405, a control signal is output to the above-described transmission circuit 306 through the input/output interface 113 so as to generate an interrogation wave applied with predetermined modulation and to transmit it to the RFID tag circuit element To for label production as a writing target through the loop antenna LC as an inquiry command signal in order to obtain ID information stored in the RFID tag circuit element To for label production. The inquiry command signal is a tag ID reading command signal in this example. As a result, the memory part (not shown) of the RFID tag circuit element To for label production is initialized.

After that, at Step S415, a reply signal including the tag ID transmitted from the RFID tag circuit element To for label production as a writing target responding to the tag ID reading command signal is received through the loop antenna LC and taken in through the receiving circuit 307 and the input/output interface 113.

Subsequently, at Step S420, on the basis of the received reply signal, it is determined if the tag ID of the RFID tag circuit element To for label production is normally read or not.

If the determination is not satisfied, the routine goes on to Step S425, where one is added to M, and moreover, at Step S430, it is determined if M=5 or not. In the case of M<4, the determination is not satisfied and the routine returns to Step S405 and the same procedure is repeated. In the case of M=5, the routine goes on to Step S435, where an error display signal is output to the PC 118 through the input/output interface 113 so that corresponding writing failure, that is, error display is made and moreover, at Step S437, the flag F=1 is set and this routine is finished. In this way, even if initialization is not successful, retry is made up to 5 times.

If the determination at Step S420 is satisfied, the routine goes to Step S440, where a control signal is output to the transmission circuit 306 so as to carry out predetermined modulation, and an interrogation wave applied with predetermined modulation is transmitted to the RFID tag circuit element To for label production as an information writing target through the loop antenna LC as a signal to write desired data in the memory part of the applicable tag by specifying the tag ID read at Step S415 and the information is written. The signal to is a Write command signal in this example.

After that, at Step S445, a control signal is output to the transmission circuit 306 to apply predetermined modulation, and a signal to read data recorded in the memory part of the applicable tag by specifying the tag ID read at Step S415 is transmitted to the RFID tag circuit element To for label production as an information writing target through the loop antenna LC, and reply is prompted. The signal is a Read command signal in this example. After that, at Step S450, a reply signal transmitted from the RFID tag circuit element To for label production as an information writing target in response to the Read command signal is received through the loop antenna LC and taken in through the receiving circuit 307.

Subsequently, at Step S455, on the basis of the received reply signal, the information stored in the memory part of the RFID tag circuit element To for label production is verified, and it is determined if the above-described transmitted predetermined information has been normally stored in the memory part or not using a known error detection code, such as Cyclic Redundancy Check (CRC) code.

If the determination is not satisfied, the routine goes to Step S460, where one is added to N, and it is further determined at Step S465 if it is N=5 or not. In the case of N<4, the determination is not satisfied and the routine returns to Step S440, where the similar procedure is repeated. In the case of N=5, the routine goes to the above-described Step S435, where a corresponding writing failure, that is, error display is similarly made on the PC 118, the flag F=1 is set at Step S437, and this routine is finished. In this way, even if information writing is not successful, retry is made up to 5 times.

If the determination at Step S455 is satisfied, the routine goes to Step S470, a control signal is output to the transmission circuit 306, and an interrogation wave applied with predetermined modulation as a signal, that is, a lock command signal in this example prohibiting overwriting of data recorded in the memory part of the applicable tag by specifying the tag ID read at Step S415 is transmitted to the RFID tag circuit element To for label production as an information writing target through the loop antenna LC so that writing of new information into the RFID tag circuit element To is prohibited. As a result, the writing of the RFID tag information to the RFID tag circuit element To for label production as the writing target is completed.

After that, the routine goes to Step S480, and combination of the information written in the RFID tag circuit element To for label production at Step S440 and the print information of the label print character string R already printed on the print area S by the print head 23 in response to that is output through the input/output interface 113 and the communication line NW and stored in the information server IS and the route server RS. This stored data is stored and held in a database of each of the servers IS, RS, for example, so that it can be referred to by the PC 118 as necessary. As a result, this routine is finished.

A detailed procedure of the interruption reading processing executed by the CPU 111 using the antenna unit 9 is described by using FIG. 13. With the procedure, the apparatus 1 for communicating with an RFID tag can be used as a reader even in the writing mode. That is, while the writing mode processing in FIG. 10 is operated, the interruption reading processing in FIG. 13 is also operated at the same time. Such simultaneous parallel processing can be executed, for example, by the single CPU 111 by a known method similar to the “multitask processing” often carried out in OS of a computer.

In FIG. 13, first at Step S301, a flag Fr to start execution of the above-described interruption reading processing (hereinafter referred to as an interruption flag as appropriate), a flag Fe indicating if the information was read or not (hereinafter referred to as a reading flag as appropriate), and a flag Fs indicating if the tag label tape 109 with print has been fed and reached the communication position with the loop antenna LC or not (hereinafter referred to as a reaching flag as appropriate) are initialized to zero.

After that, the routine goes to Step S302, where it is determined whether or not the interruption flag Fr=1. In other words, it is determined if a second RFID tag circuit element To of the tag label tape 109 with print has reached the communication position. Since it is Fr=0 at the beginning, the determination is not satisfied, and Step S302 is repeated and the routine stands by. If it becomes the interruption flag Fr=1 at the above-described Step S103 in FIG. 10 or Step S235 in FIG. 11, the determination at Step S302 is satisfied, and the routine goes to Step S303.

At Step S303, it is determined if all the reading flags Fe indicating whether the information reading using all the units 9, 9′ and 9″ has been completed or not are set to one or not. In other words, it is determined if the information reading from the RFID tag circuit element To for information obtainment has been completed by the interruption reading processing. If the interruption flag Fr=1 by Step S103, the interruption reading processing has not been executed yet and the information reading has not been completed, the determination is not satisfied, and the routine goes to Step S305.

At Step S305, similarly to the above-described Step S225, a control signal is output to the switching circuits 239A, 239B so as to switch the switching circuits 239A, 239B in conjunction with each other, and the input/output interface 113 is connected to the transmission circuits 316A, 316B and 316C, and the receiving circuit 317.

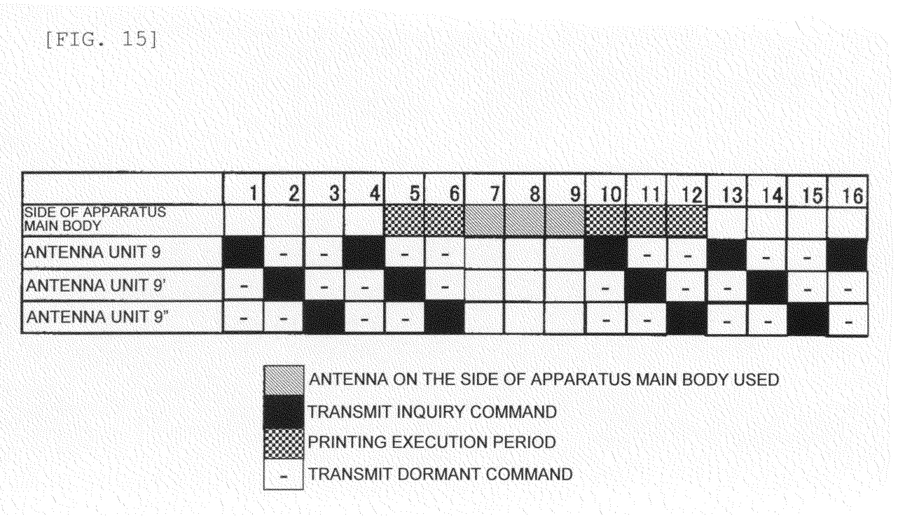

After that, the routine goes to Step S310, a control signal is output at the same time as start of a time slot corresponding to the antenna unit, synchronous with a clock signal, not shown, for example to the transmission circuit 316A, for example, provided in any one of the antenna units 9 so as to apply predetermined modulation to the carrier wave. As a result, an inquiry command signal as an obtainment processing command signal for getting information stored in the RFID tag circuit element To is generated and transmitted to the RFID tag circuit element To for information obtainment within a communication range of the antenna through the corresponding loop antenna LC1 in the above example, and a reply is prompted. Then, at the subsequent Step S330, a control signal is output also to the transmission circuits 316B, 316C in the above example provided in the remaining units of the antenna units 9, and the predetermined modulation is applied to the carrier wave. As a result, a sleep processing command signal for making the RFID tag circuit element To dormant, that is, command signal of processing for not to respond is generated and transmitted to the RFID tag circuit element To for information obtainment in the communication range of the antenna through the loop antennas LC2, LC3 in the above example. With regard to when to transmit the inquiry command signal in any of the antenna units 9, 9′ and 9″, the unit is switched according to a predetermined order set in advance, for example, each time the procedure is executed (See Step S339, which will be described later). That is, in this embodiment, on the basis of the control signal from the CPU 111, the transmission circuits 316A, 316B and 316C switch and output a command signal as access information to the antenna units 9, 9′ and 9″ at each time-divided predetermined occupied period as time slot. Namely, the transmission circuits 316A, 316B, 316C output an inquiry command signal to one unit among the antenna units 9, 9′, and 9″ while the transmission circuits 316A, 316B, 316C output the sleep processing command signal to the remaining units among the antenna units 9, 9′, and 9″. Thus, the reading is executed by operating the antenna units 9, 9′ and 9″ at the same time in a time sharing method (See FIG. 15, which will be described later).

After that, at Step S340, it is determined if a reply signal has been transmitted from the RFID tag circuit element To for information obtainment in response to the inquiry command signal transmitted at Step S310 and the reply signal has been received and taken in through the loop antenna LC1 or LC2 or LC3 and the receiving circuit 317 or not. If the reply signal has not been received, the determination is not satisfied, and the routine goes to Step S335, where it is determined if the reaching flag Fs=1 or not. The determination is not satisfied till the tag label tape 109 with print has reached the communication position with the loop antenna LC, and the routine goes to Step S337. At Step S337, it is determined if the time slot started corresponding to the antenna units 9 as described above has been already finished or not. If the time slot has not been finished yet, the determination is not satisfied, and the routine returns to Step S310, and the similar procedure without changing which of the antenna units 9, 9′ and 9″ is the inquiry command signal and which is the sleep processing command signal is repeated from the transmission of the two command signals. On the other hand, if the time slot has been finished, the determination at Step S337 is satisfied, the unit in the antenna units 9, 9′ and 9″ to which the transmission of the inquiry command signal is switched to the subsequent order at Step S339, and the routine returns to Step S310. In other words, Step S339 performs order switching processing. Then, in conjunction with the start of the time slot corresponding to the antenna units 9 to which the inquiry command signal is allocated this time the inquiry command signal is transmitted from one of the antenna units 9 of this turn. If the sleep processing command signal has been transmitted at the previous time, prior to the inquiry command signal, an activation processing command signal for start capable of information reading again is transmitted in advance for activation. The same applies to the following. Then, the similar procedure is repeated thereafter.

On the other hand, if the reply signal has been received at Step S340, the determination is satisfied, and the routine goes to Step S350. At Step S350, the RFID tag information obtained from the RFID tag circuit element To for information obtainment as a writing target is temporarily stored in an appropriate storage device such as the RAM 117. In the RFID tag information obtained at this time, an identifier indicating by which antenna, in other words, by which antenna unit, it is received is given when being processed by the receiving circuit 317 through the antenna sharing devices 250A to 250C from the antennas LC1 to LC3, for example, so that the antenna can be identified, in other words, it functions as an antenna identification portion. After that, the RFID tag information automatically read from the storage device is output through the input/output interface 113 and the communication line NW, for example, and stored in the information server IS and the route server RS. The stored data is stored and held in a database of each of the servers IS, RS, for example, so that it can be referred to by the PC 118 as necessary.

After that, at Step S351, it is determined if the reading of the corresponding RFID tag circuit element To has been finished in all the connected antenna units 9 or not. If the reading of all the antenna units 9 has not been finished yet, the determination is not satisfied, and the unit to which the transmission of the inquiry command signal is allocated similarly to Step S339 is switched to the subsequent order at Step S352. In other words, the Step S351 performs order switching processing. Then, the routine returns to Step S310, where the similar procedure is repeated. If the reading has been finished for all the units, the determination at Step S351 is satisfied, and the routine goes to Step S353.

At Step S353, all the reading flags Fe=1 are set in response to the completion determination of the interruption reading processing of all the units at Step S351, and they are returned to the flag Fr=0 at Step S355, and the routine returns to Step S302 and returns to the standby state of Fr=1 similarly to the above.

On the other hand, at the above-described Step S302, if the reading processing has been completed for all the antenna units 9 and the information has been obtained as described above, since all the reading flags Fe=1 are set at Step S353, the determination at Step S303 is satisfied, and the routine goes to Step S355, where Fr=0 is set and the routine returns to Step S302 again. On the other hand, if the reply signal has not been received and the information has not been obtained in the interruption reading processing already executed once, in other words, if the determination at Step S335 is satisfied before the reading is completed, and the routine has gone to Step S355, since Step S353 is skipped and the reading flag Fe=1 is not set, the determination at Step S303 is not satisfied, and the routine goes to Step S305, and the procedure of information reading at Step S305 and after is executed again.

As described above, in the writing mode processing, first, by setting the interruption flag Fr=1 at Step S103, the interruption reading processing to the RFID tag circuit element To for information obtainment is started, and till the RFID tag circuit element To for label production has reached the communication position by the feeding of the tag label tape 109 with print and the information writing is started, the reading processing is executed. When the communication position is reached, by setting the reaching flag Fs=1 at Step S223, the reading processing with respect to the RFID tag circuit element To for information obtainment is interrupted from Step S335. After that, when the information writing in the RFID tag circuit element To for label production is finished, by setting the interruption flag Fr=1 at Step S235 again, the interruption reading processing with respect to the RFID tag circuit element To for information obtainment is resumed. At this time, during the time slot allocated to one of the antenna units 9, the transmission of the inquiry command signal is repeated till the reply signal is received, and if the time slot is finished while the signal is not received, the similar procedure is executed for the subsequent antenna units 9 in the subsequent time slot, and they are repeated till the information reading relating to all the antenna units 9 is completed, when this routine is finished.

A detailed procedure of the reading mode processing at Step S300 executed in the reading mode using the apparatus 1 as a reader using the antenna unit 9 is described by using FIG. 14. The same reference numerals are given to the procedures similar to those in FIG. 13, and description will be omitted or simplified as appropriate.

In FIG. 14, first, at Step S305 similar to FIG. 13, the switching circuits 239A, 239B are switched, and the input/output interface 113 is connected to the transmission circuits 316A, 316B and 316C, and the receiving circuit 317.

After that, at Step S310 and Step S330 similar to FIG. 13, an inquiry command signal is generated and transmitted by the transmission circuit 316A, which is one of the antenna units 9, and a sleep processing command signal is generated and transmitted by the transmission circuits 316B, 316C of the remaining antenna units.

After that, the routine goes to Step S340 similarly to the above, and it is determined if a reply signal has been received from the RFID tag circuit element To for information obtainment or not. In the case of not having been received, if the time slot has not been finished at Step S337, the routine returns to Step S310, and the similar procedure is repeated. If the time slot has been finished, the determination at Step S337 is satisfied, the unit to which the transmission of the inquiry command signal is allocated is switched to the subsequent order at Step S339, the routine returns to Step S310, and the similar procedure is repeated.

At Step S340, if the reply signal has been received, the determination is satisfied, the routine goes to Step S350 similarly to the above, the RFID tag information obtained from the RFID tag circuit element To for information obtainment is output, and it is determined if the reading has been finished or not for all the antenna units 9 at Step S351 similarly to the above. If the reading of all the antenna units 9 has not been finished yet, the determination is not satisfied, and after the order switching processing at Step S352, the routine returns to Step S310, and the similar procedure is repeated. If the reading has been finished for all the units, the determination at Step S351 is satisfied, and this routine is finished.

An example of a behavior of the above time sharing is described by using FIG. 15.

In FIG. 15, each time slot indicated by “1”, “2”, “3”, and “4”, respectively, in the figure corresponds to the communication with the RFID tag circuit element To for information obtainment executed in the reading mode processing shown in FIG. 14 while the command signal of the antenna units 9, 9′ and 9″ are sequentially switched, in other words, the antenna unit to transmit the inquiry command signal is sequentially switched.

Each time slot indicated by “5” to “12” in the figure corresponds to the procedure executed in the writing mode processing. First, each time slot indicated by “5” and “6” in the figure corresponds to the communication with the RFID tag circuit element To for information obtainment executed in the interruption reading mode processing shown in FIG. 13 while the command signals of the antenna units 9 are sequentially switched, in other words, the antenna unit to transmit the inquiry command signal is sequentially switched along the order of the antenna unit 9′, the antenna unit 9″, in this example. When seen on the side of the apparatus main body 2, the procedure corresponds to Step S115 in the flow of FIG. 10 to Step S220 shown in FIG. 11.

After that, each time slot indicated by “7”, “8”, and “9” in the figure corresponds to Step S400 in the flow shown in FIG. 11 on the side of the apparatus main body 2.

Each time slot indicated by “10”, “11”, and “12” in the figure corresponds to the communication with the RFID tag circuit element To for information obtainment executed in the interruption reading mode processing shown in FIG. 13 while the command signals of the antenna units 9 are sequentially switched, in other words, the antenna unit to transmit the inquiry command signal is sequentially switched along the order of the antenna unit 9′, the antenna unit 9″ in this example. When seen on the side of the apparatus main body 2, they correspond to Step S230 in the flow in FIG. 11 to Step S160 shown in FIG. 10.

Each time slot indicated by “13”, “14”, “15” and “16” in the figure corresponds to the communication with the RFID tag circuit element To for information obtainment executed in the reading mode processing shown in FIG. 14 while the command signals of the antenna units 9, 9′, and 9″ are sequentially switched, in other words, the antenna unit to transmit the inquiry command signal is sequentially switched.

In the above, Step S310, Step S330, and Step S339 in FIGS. 13 and 14 executed by the control circuit 110 constitute a control portion configured to control a plurality of information creation devices so that one information creation device among the plurality of information creation devices generates the obtainment processing command signal while the remaining information creation devices generate command signals of processing for not to respond.

In the embodiment described as above, in the writing mode execution, the information is written in the RFID tag circuit element To for label production provided in the tag label tape 109 with print through the loop antenna LC, and moreover, when the tag label tape 109 with print is cut off, the RFID label T with print is produced. On the other hand, in the reading mode execution, the information stored in the RFID tag circuit element To for information obtainment located outside the housing 200 is read through the loop antennas LC1, LC2 and LC3 provided at the antennas 9, 9′ and 9″, respectively, and obtained. Since using the single apparatus 1 for communicating with an RFID tag, both the tag label production processing and the information reading processing as information obtain processing can be executed in this way, as compared with the case in which an apparatus for producing a label and an information reading apparatus are prepared separately, the apparatus configuration can be simplified and cost burden on a user can be reduced.

In the reading mode execution, plural types of the inquiry command signals generated and transmitted substantially at the same timing by the transmission circuits 316A to 316C are transmitted to the RFID tag circuit element To by the antennas LC1 to LC3, and a response signal received at the antennas LC1 to LC3 from the RFID tag circuit element To in response to that is received and processed by the common single receiving circuit 317 and the reading information is obtained. Particularly in this embodiment, the inquiry command signal is generated and transmitted from one of the transmission circuits 316A to 316C. The sleep processing command signal is generated and transmitted by the remaining transmission circuits, and the RFID tag circuit element To having received the sleep processing command signal is made dormant and will not respond thereafter. As a result, without particularly providing a switch to selectively connect to the antennas LC1 to LC3, a function equivalent to the selective use of any one of the antennas LC1 to LC3, that is, the one transmitting the inquiry command signal, can be obtained. As a result, convenience for the operator can be improved.

Particularly in this embodiment, at Step S310 and Step S330 in the flow shown in FIGS. 13 and 14, the inquiry command signal is generated and transmitted from one of the transmission circuits 316A to 316C and the sleep processing command signal is generated and transmitted from the remaining transmission circuits, and moreover, the single transmission circuit generating the inquiry command signal is sequentially switched at Step S352 and Step S339. As a result, a function equivalent to selective use of any one, that is, the one transmitting the inquiry command signal of the antennas LC1 to LC3 all the time and sequential switching of the antenna to be selected can be obtained. As a result, convenience for the operator can be improved.

In the above, the sleep processing command signal for making the RFID tag circuit element To dormant is used as the command signal of processing for not to respond, but not limited to that. That is, a so-called response-refusing command signal to have the RFID tag circuit element To refuse a response to the inquiry command signal while the RFID tag circuit element To is not made dormant but maintained in the standby state may be used, for example. In this case, too, an equivalent effect can be obtained.

Also, when one of the transmission circuits 316A to C generating the inquiry command signal as above is switched, in other words, when the antennas LC1 to 3 outputting the inquiry command signal is switched, a lighting display device (not shown) constructed by an LED may be provided at the housing 200 or each of the antenna units 9 so as to make lighting display corresponding to the switched state, for example. As a result, which of the antennas LC1 to LC3 tries to obtain the information from the RFID tag circuit element To can be clearly and visually notified to the operator.

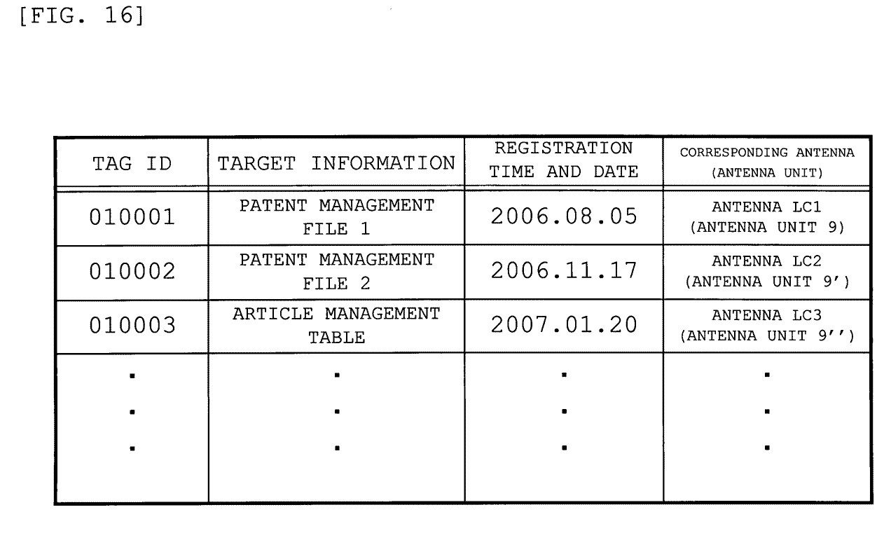

Also, particularly in this embodiment, at step S350 in the flow shown in FIGS. 13 and 14, the identifier indicating by which of the antennas, in other words, by which of the antenna units the information is received is given to the RFID tag information. As a result, when the RFID tag information is stored in the information server IS and the route server RS, it is stored including the identifier. Therefore, when the RFID tag information is referred to by the PC 118, an arranged location of the RFID tag circuit element To from which the information is obtained can be roughly identified on the basis of the communication range of the corresponding antennas LC1 to LC3. The reading information and the identifier indicating the antenna identification result are described by using FIG. 16. The reading information and the identifier are stored in the RAM 117 in the control circuit 110 or other storage device in and outside the apparatus, buffer memory, for example. The RAM 117 or the storage device functions as a reading information storage device. In this case, the storage device may be only one though receiving is conducted from three antennas LC1 to LC3. The reading information, that is, the information stored in the RFID tag circuit element To for information obtainment is the tag ID only, and it may be so configured that information corresponding to that such as associated target information is stored in the information server IS. Otherwise, the tag ID and the target information are stored in the RFID tag circuit element To for information obtainment. Alternatively, as in FIG. 16, instead of sequential storage of the corresponding antenna information as antenna unit information in association with each tag ID and the target information in the storage device, it may be so configured that a plurality of storage areas divided for each of the corresponding antennas, that is, antenna units is formed in advance in the storage device so that each tag ID and the target information are sorted and stored in the corresponding storage area.

Such a method is particularly convenient if a plurality of the PCs 118 for the above operation is connected to the apparatus main body 2 through the communication line NW and the antenna units 9 are arranged in the vicinity of each of the PCs 118 as an example.

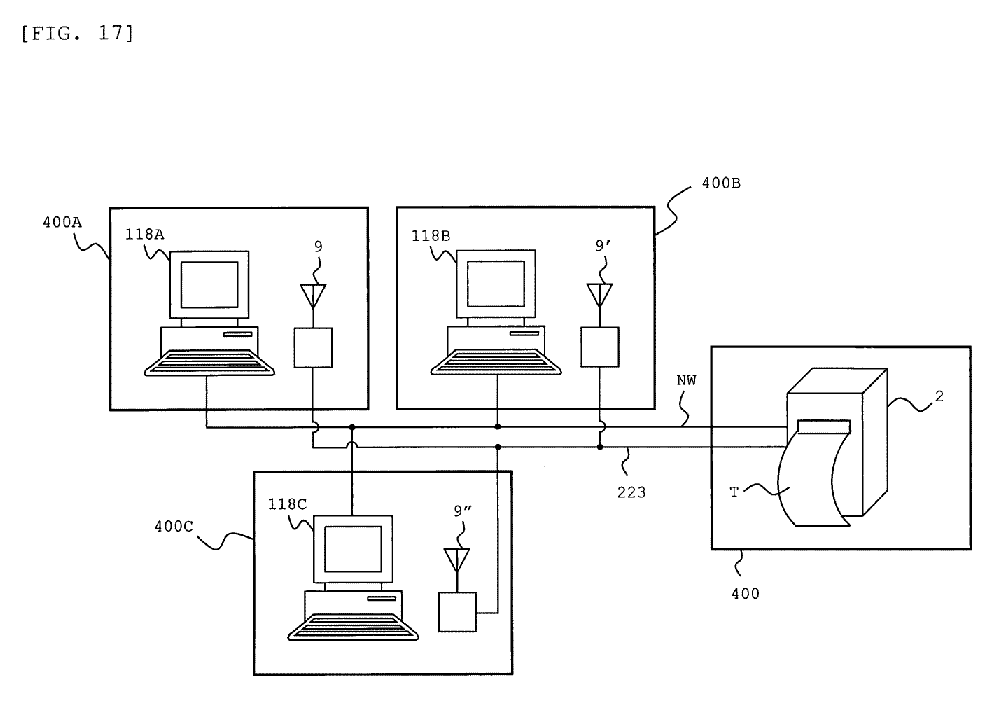

As shown in FIG. 17, the apparatus main body 2 of the apparatus 1 for communicating with an RFID tag is arranged on a single desk 400. On another three desks 400A, 400B and 400C, PCs 118A, 118B and 118C as operation terminals connected to the apparatus main body 2 through the communication line NW are arranged, respectively. On each of the desks 400A, 400B and 400C, the antenna units 9, 9′ and 9″ connected to the apparatus main body 2 through the above-described cable 223 are arranged, respectively so that they are located in the vicinities of the PCs 118A, 118B and 118C.

With the above arrangement, if the RFID tag information obtained at Step S350 is received by the antenna unit 9, the corresponding RFID tag circuit element To can be identified to be located close to the desk 400A, if it is received by the antenna unit 9′, the corresponding RFID tag circuit element To is to be located close to the desk 400B, and if it is received by the antenna unit 9″, the corresponding RFID tag circuit element To is to be located close to the desk 400C.

In this case, it may be further configured at Step S350 that the RFID tag information is output to the PCs 118A to 118C associated with the identified antennas LC1 to LC3 as above through the communication line NW. The Step S350 functions as an information sorting portion that determines a terminal to which the information is output. By automatically delivering the information to the corresponding PCs 118A to C on the basis of the identifiers given in advance, the applicable PC 118 is automatically set as an output destination without cumbersome manual setting by the operator each time. As a result, the operation burden on the operator can be reduced, and convenience can be improved.

Also, since each of the above-described time slots described using FIG. 15 is usually set to a relatively short period, if many collisions of the reply signals are detected during the period, it is supposed that there are extremely large number of RFID tag circuit elements To as reading targets of the applicable antenna. It may also be so configured that, by setting the corresponding time slot longer according to a collision frequency of the reply signals in response to that, the reply signals from a large number of RFID tag circuit elements To can be smoothly received. A example of the above-described method for setting the corresponding time is a setting such that the determination time at Step S337 in FIGS. 13 and 14 is made different according to the antenna, for example.

Also, in order to start the RFID tag circuit element To which was once applied with the sleep processing by the sleep processing command signal again by the above-described activation processing command signal so that the information can be read again, a predetermined time is required after the signal is transmitted. Thus, among the antennas LC1 to LC3, the one having a high collision frequency and for which presence of a large number of RFID tag circuit elements To is assumed, the above-described response-refusing command signal may be generated by the corresponding transmission circuits 316A to 316C instead of the sleep processing command signal. As a result, start of a large number of RFID tag circuit elements To can be realized smoothly, and efficiency of the entire reading processing can be improved.

Moreover, for the antenna having a high collision frequency and for which presence of a large number of RFID tag circuit elements To is assumed, the above-described activation processing command signal may be transmitted not at the start of the time slot at which the inquiry command signal is transmitted from the applicable antenna but at a timing slightly earlier than that, that is, in the final section of the time slot immediately before, for example. As a result, start of a large number of RFID tag circuit elements To can be realized more smoothly, and efficiency of the reading processing can be improved.

In the above, the case in which the RFID tag information is transmitted to the RFID tag circuit element To for label production and writing is carried out in the IC circuit part 151 so as to produce the RFID label T is described, but not limited to that. That is, the present invention can also be applied to a case in which, while the RFID tag information is read from the read-only RFID tag circuit element To for label production in which the predetermined RFID tag information is unrewritably stored and held in advance, printing corresponding to that is performed so as to produce the RFID label T, and in this case, too, the effect similar to the above can be obtained.

Also, in the above, the method in which the printing is performed on the cover film 103 separate from the base tape 101 provided with the RFID tag circuit element To for label production and they are bonded with each other, but not limited to that, the present invention may be applied to a method, that is, not-bonding method in which the printing is performed on a print area on a print-receiving tape layer provided in the tag tape, for example.

Also, in the above, the case in which the tag label tape 109 with print for which the print and access, that is, reading or writing to the RFID tag circuit element To for label production have been finished is cut off by the cutting mechanism 15 so as to produce the RFID label T is described as an example, but not limited to that. That is, if label mounts as so-called die-cut labels separated in advance to a predetermined size corresponding to the label are sequentially arranged on the tape fed out of the roll. The accessed RFID tag circuit element To for label production is provided on the label mount and the corresponding print has been applied on it. The RFID label T may be produced by peeling off only the label mount from the tape after the tape is discharged from the label carry-out exit 11 without cutting it by the cutting mechanism 15. The present invention can also be applied to such a case.

Moreover, in the above, the case in which the tag label tape 109 with print is used so as to produce the RFID label T with print is described as an example, but not limited to that, the present invention may be also applied to production of the RFID label T without print.

Other than those described above, methods of the embodiments and each variation may be combined as appropriate for use.

Though not specifically exemplified, the present invention should be put into practice with various changes made in a range not departing from its gist.

What is claimed is:

1. An apparatus for reading with a radio frequency identification (RFID) tag comprising:
a plurality of information creation devices, capable of generating a plurality of types of command signals for making an access to an RFID tag circuit element having an IC circuit part storing information and a tag antenna that transmits and receives information;
a plurality of apparatus antennas connected to said plurality of information creation devices, respectively, and configured to transmit said plurality of types of command signals to said RFID tag circuit element via radio communication substantially at the same timing; and
a single information processing device configured to obtain reading information by means of receiving processing of a response signal transmitted from said RFID tag circuit element according to said command signal transmitted from said apparatus antenna and received by said apparatus antenna.

2. The apparatus according to claim 1, wherein:
each of said plurality of information creation devices has a carrier-wave modulation device configured to receive a carrier wave generated by a carrier-wave generation device in common to each other and to modulate the carrier wave received.

3. The apparatus according to claim 1, wherein:
said plurality of information creation devices generates said plurality of types of command signals including an obtainment processing command signal that carries out obtainment processing for said RFID tag information of said IC circuit part and a command signal of processing for not to respond that carries out processing for said RFID tag circuit element not to respond.

4. The apparatus according to claim 3, wherein:
said plurality of information creation devices generates said plurality of types of command signals including a sleep processing command signal that makes a function of said RFID tag circuit element sleep as said command signal of processing for not to respond.

5. The apparatus according to claim 3, further comprising a control portion configured to control said plurality of information creation devices so that one of said plurality of information creation devices generates said obtainment processing command signal and the remaining information creation devices of said plurality of information creation devices generate said command signal of processing for not to respond.

6. The apparatus according to claim 5, wherein:
said control portion controls said plurality of information creation devices so that said one information creation device that generates said obtainment processing command signal is sequentially switched.

7. The apparatus according to claim 6, further comprising a lighting display device configured to make lighting display corresponding to a switched state of said information creation device that generates said obtainment processing command signal, said switched state being executed by a control of said control portion.

8. The apparatus according to claim 5, further comprising an antenna identification portion configured to identify said apparatus antenna that conducted communication with said RFID tag circuit element according to said reading information obtained by said information processing device on the basis of the response signal received by said apparatus antenna.

9. The apparatus according to claim 8, wherein:
each of said plurality of apparatus antennas is provided at antenna unit corresponding to the apparatus antenna from a plurality of antenna units, each antenna unit being connected to a operating terminal corresponding to the antenna unit from a plurality of operation terminals.

10. The apparatus according to claim 9, further comprising an information sorting portion configured to determine the operation terminal to become an output destination of said reading information obtained by said information processing device or information corresponding to said reading information among said plurality of operation terminals on the basis of an result of identification by said antenna identification portion.

11. The apparatus according to claim 8, further comprising a reading information storage device configured to store said reading information obtained by said information processing device on the basis of the response signal received by said apparatus antenna in association with an result of identification by said antenna identifying portion.
